(19) United States
(12) Patent Application Publication
(10) Pub. No.: US 2024/0103799 A1
(43) Pub. Date: Mar. 28, 2024

(54) IMMERSIVE AUDIO EXPERIENCES BASED ON VISUAL CONTENT OR OBJECTS

(71) Applicant: Sonos, Inc., Santa Barbara, CA (US)

(72) Inventors: Adam Kumpf, Delaware, OH (US); Roger Jackson, Seattle, WA (US); Dayn Wilberding, Portland, OR (US); Dana Krieger, Emeryville, CA (US); Philippe Vossel, Wuppertal (DE)

(21) Appl. No.: 18/474,559

(22) Filed: Sep. 26, 2023

Related U.S. Application Data
(60) Provisional application No. 63/377,495, filed on Sep. 28, 2022.

(51) Int. Cl. G06F 3/16

(52) U.S. Cl. CPC G06F 3/165

(57) ABSTRACT

Systems and methods for controlling media playback via physical tokens (e.g., items of media content such as photographs) are disclosed. A media playback system can include an audio playback device and a control device. The control device includes a sensor configured to sense a tag of the physical token. The control device can obtain data by sensing the tag of the physical token via the sensor. Based on the obtained data, the control device transmits a request for media content to one or more remote computing devices associated with a media content service, and causes playback of the requested media content via the audio playback device. Additionally or alternatively, spatial audio content can be generated and played back based on a media item characteristic obtained via the sensor data.

### CROSS-REFERENCE TO RELATED APPLICATION(S)

This application claims priority to U.S. Provisional Application No. 63/377,495, filed Sep. 28, 2022, which is hereby incorporated by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, examples, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with examples of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partially schematic diagram of a control device.

FIG. 2 is a schematic diagram of a media playback system in accordance with examples of the disclosed technology.

FIGS. 3A-3F illustrate various examples of physical tokens for controlling media playback in accordance with the disclosed technology.

FIGS. 4-9 are flow diagrams illustrating example methods in accordance with the disclosed technology.

The drawings are for the purpose of illustrating example examples, but those of ordinary skill in the art will understand that the technology disclosed herein is not limited to the arrangements and/or instrumentality shown in the drawings.

### DETAILED DESCRIPTION

### I. Overview

In a typical media playback system, media can be selected for playback via an application (e.g., SONOS app) associated with the media playback system, an application (e.g., SPOTIFY, PANDORA, APPLE Airplay-compatible applications) associated with a media content provider, and/or voice control. While any of these three approaches offers significant advantages over previous legacy approaches that typically require manipulation of the physical media (e.g., vinyl LP, cassette, compact disc), there remains an opportunity to improve the user experience by decreasing the “time to music” and by providing greater accessibility to visually impaired users, the elderly, users lacking fine motor skills, and/or children who may lack a mobile device or the ability to use voice control. Moreover, some users may miss the feeling of controlling media playback via a tangible means while also appreciating the convenience of modern control approaches. In some instances, use of physical tokens for playback can introduce a desirable sense of playfulness or interactivity, for instance in the context of public spaces (e.g., interactive retail displays, restaurants, classrooms, communal jukebox, etc.).

Examples of the present technology can address these and other shortcomings. Rather than receiving control commands via an application and/or voice control, the media playback system can be controlled via physical tokens associated with media content. In some examples, for instance, a physical token (e.g., a disc-shaped object) has a tag embedded therein and/or printed thereon. A database stored locally and/or on the cloud can include a mapping of the tag and corresponding target media content. In some examples, the tags can include at least one of a near-field communication (NFC) tag, a radio frequency identification (RFID) tag, a QR code, a bar code, etc. In some instances, identifiers such as QR codes or bar codes traditionally printed in visible ink can instead be applied to the object in a visually inconspicuous way (e.g., via infrared ink) such that a printed identifier may not be readily visible to the naked eye, but nonetheless readable by a control device. In various examples, physical tokens can be used to provide novel control functionality, such as dynamically modifying generative audio, creating playlists on the fly, modulating lighting conditions, controlling playback (e.g., adjusting volume, skipping tracks, play/pause, etc.) or a number of other actions for selecting, modifying, and/or controlling media playback.

This token-based control approach can also be used to enhance the user experience of viewing media items such as photographs or videos. The combination of sound and an image or video can be a powerful way to re-live or unlock a memory. Some photo applications record “live photos” that include a short video (e.g., approximately 3 seconds) with accompanying sound. A short media clip with mono or even stereo sound, however, ultimately fails to immerse the user back into the scene of the original photo or video, particularly if played back via the user's mobile device with limited audio playback capabilities. Examples of the present technology can address these and other problems by providing accompanying audio content (e.g., spatial audio) for particular media items (e.g., photographs, videos) that can be played back via out-loud playback devices (and/or via in-ear or over-ear headphone playback devices) to create a more immersive listening and viewing experience. In some instances, the audio generated or selected can be modified and/or seamlessly looped to provide a continuous soundtrack to the user's viewing of the media item. As the user switches to another media item, new corresponding audio content can be selected and/or generated for accompanying playback. In various examples, the accompanying audio content can be selected and/or generated based on characteristics of the media item. For example, if the media item is a family photograph on a beach, the accompanying audio can include beach sounds such as crashing waves and seagull calls. As another example, if the media item is a video of a child's first steps, the accompanying audio can include happy, up-beat music.

To achieve this effect, items of media content (e.g., images, videos, etc.) can themselves be used as tokens to control playback of corresponding media content. Tags can be embedded in, carried by, or coupled to the media items (e.g., using QR codes, NFC tags, or other tags positioned adjacent to or overlaid with the media items, etc.). In some implementations, the media items (or other meaningfully tagged artifacts) can be inspected directly using one or more sensors, for instance using optical or other image analysis to identify particular media item(s) or extract features of media items (e.g., identifying certain people, locations, objects present in the media items, etc.). After identifying the media item (or characteristics of the media item), suitable audio content can be selected for playback to accompany the user's viewing experience. The audio content may be pre-recorded and/or pre-selected media content that corresponds to the identified media item(s), or alternatively may be generative audio that is produced based on one or more characteristics of the media item(s). In some implementations, the audio content can take the form of spatial audio (e.g., audio including both lateral and height channels), which can provide a more immersive listening experience when played back via spatial-capable audio playback devices. As a result, a user's experience while viewing her photographs or videos can be enhanced with dynamic, immersive, and contextually appropriate audio content to accompany the particular media item(s) the user is reviewing.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

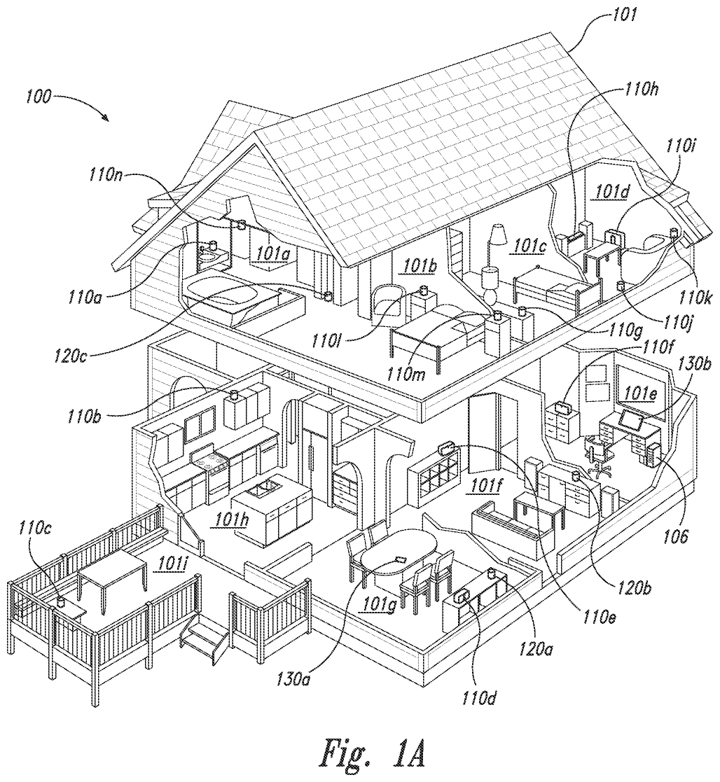

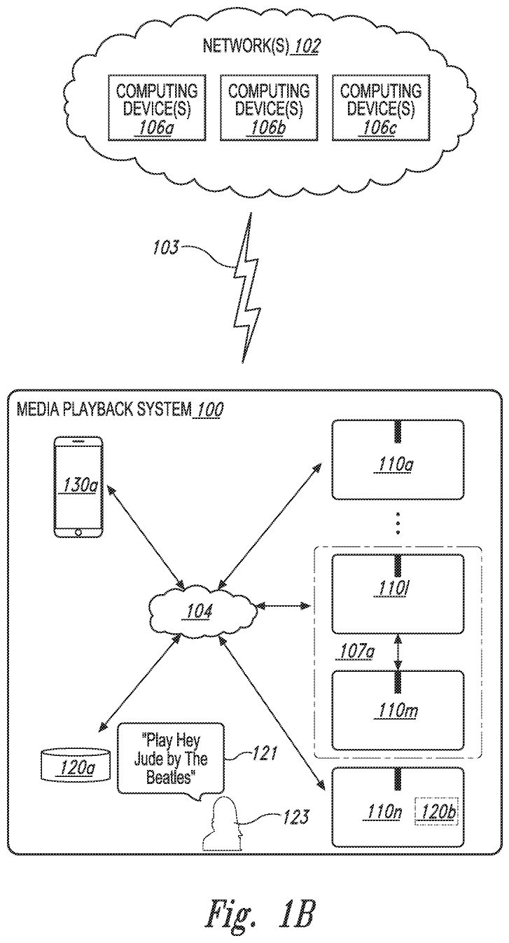

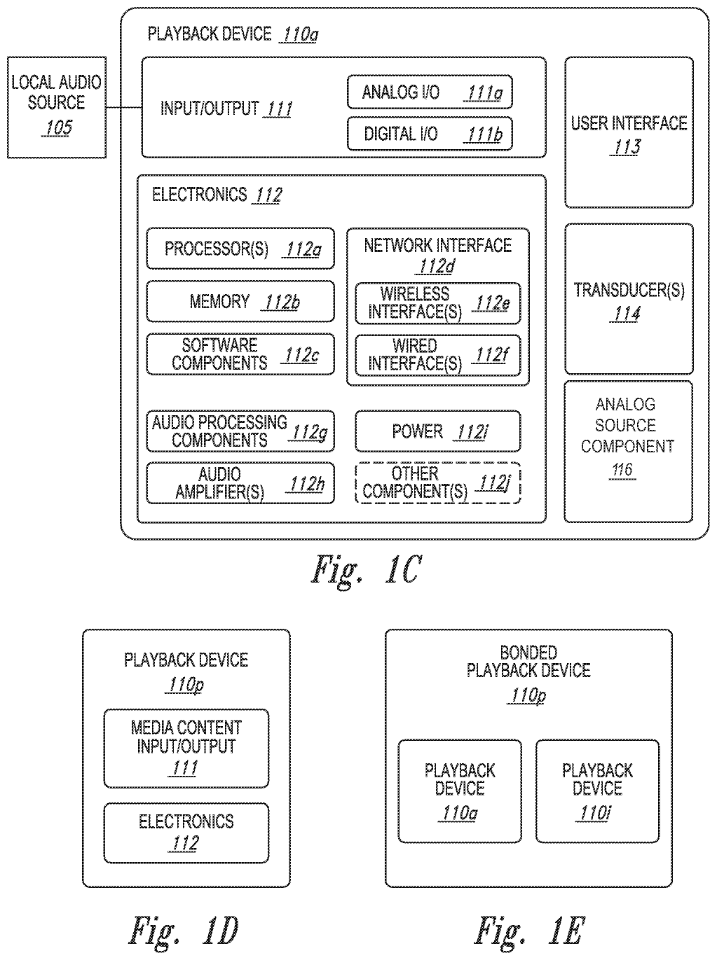

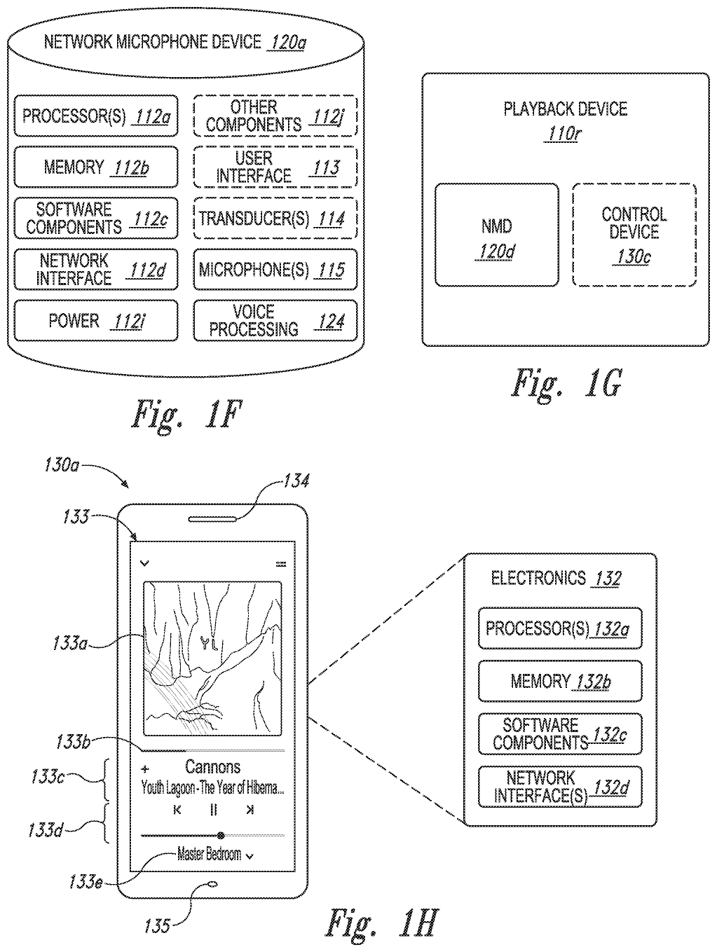

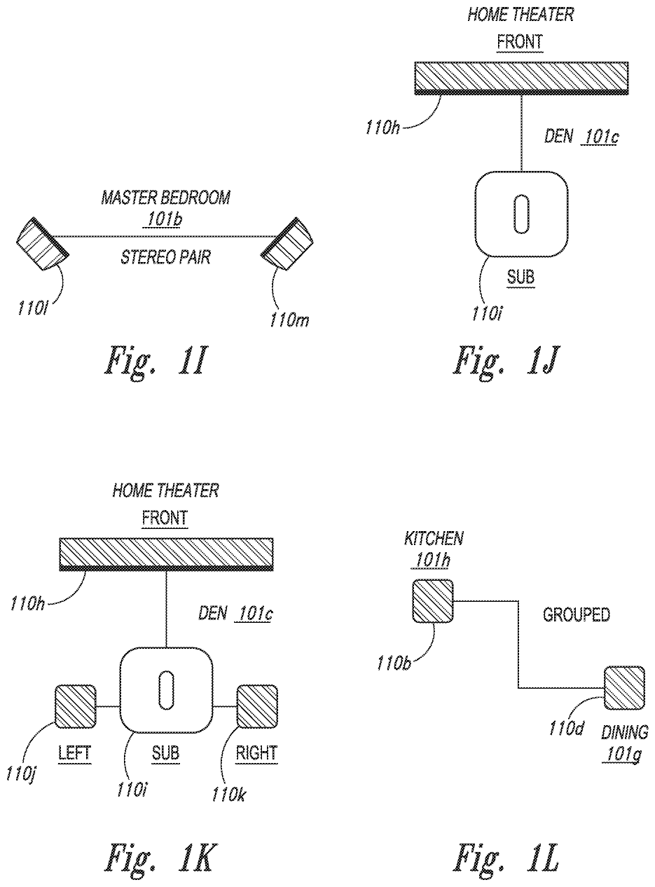

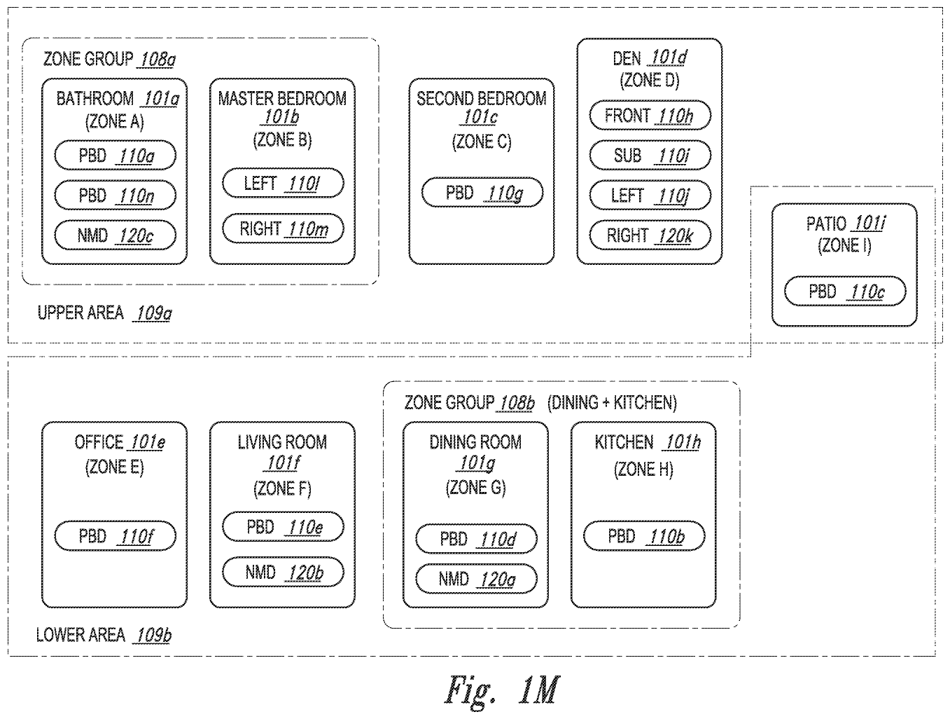

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular examples of the disclosed technology. Accordingly, other examples can have other details, dimensions, angles and features without departing from the spirit or scope of the disclosure. In addition, those of ordinary skill in the art will appreciate that further examples of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio, visual content, or both audio and visual content. In some examples, a playback device includes one or more transducers or speakers powered by one or more amplifiers. In other examples, however, a playback device includes one of (or neither of) the speaker and the amplifier. For instance, a playback device can comprise one or more amplifiers configured to drive one or more speakers external to the playback device via a corresponding wire or cable. In some embodiments, a playback device includes a display component (e.g., a screen, projector, etc.) or is otherwise communicatively coupled to a display component for the playback of visual content.

Moreover, as used herein the term NMD (i.e., a “network microphone device”) can generally refer to a network device that is configured for audio detection. In some examples, an NMD is a stand-alone device configured primarily for audio detection. In other examples, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain examples, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some examples, for instance, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various examples of the disclosure are described in greater detail below.

In the illustrated example of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain examples and examples are described below in the context of a home environment, the technologies described herein may be implemented in other types of environments. In some examples, for instance, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some examples, a single playback zone may include multiple rooms or spaces. In certain examples, a single room or space may include multiple playback zones.

In the illustrated example of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some examples, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some examples, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some examples, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some examples, one or more of the computing devices 106 comprise modules of a single computer or server. In certain examples, one or more of the computing devices 106 comprise one or more modules, computers, and/or servers. Moreover, while the cloud network 102 is described above in the context of a single cloud network, in some examples the cloud network 102 comprises a plurality of cloud networks comprising communicatively coupled computing devices. Furthermore, while the cloud network 102 is shown in FIG. 1B as having three of the computing devices 106, in some examples, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. Additionally or alternatively, received media content can include prompts or other inputs for generative media content, which may be generated partially or entirely locally via one or more of the local playback devices 110. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some examples, the network 104 comprises a dedicated communication network that the media playback system 100 uses to transmit messages between individual devices and/or to transmit media content to and from media content sources (e.g., one or more of the computing devices 106). In certain examples, the network 104 is configured to be accessible only to devices in the media playback system 100, thereby reducing interference and competition with other household devices. In other examples, however, the network 104 comprises an existing household communication network (e.g., a household WiFi network). In some examples, the links 103 and the network 104 comprise one or more of the same networks. In some examples, for instance, the links 103 and the network 104 comprise a telecommunication network (e.g., an LTE network, a 5G network). Moreover, in some examples, the media playback system 100 is implemented without the network 104, and devices comprising the media playback system 100 can communicate with each other, for example, via one or more direct connections, PANs, telecommunication networks, and/or other suitable communication links.

In some examples, audio content sources may be regularly added or removed from the media playback system 100. In some examples, for instance, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some examples, for instance, the media content database is stored on one or more of the playback devices 110, network microphone devices 120, and/or control devices 130.

In the illustrated example of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain examples, for instance, the group 107a comprises a bonded zone in which the playback devices 110l and 110m comprise left audio and right audio channels, respectively, of multi-channel audio content, thereby producing or enhancing a stereo effect of the audio content. In some examples, the group 107a includes additional playback devices 110. In other examples, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated example of FIG. 1B, the NMD 120a is a standalone device and the NMD 120d is integrated into the playback device 110n. The NMD 120a, for example, is configured to receive voice input 121 from a user 123. In some examples, the NMD 120a transmits data associated with the received voice input 121 to a voice assistant service (VAS) configured to (i) process the received voice input data and (ii) transmit a corresponding command to the media playback system 100. In some examples, for instance, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some examples, the analog I/O 111a is an audio line-in input connection comprising, for example, an auto-detecting 3.5 mm audio line-in connection. In some examples, the digital I/O 111b comprises a Sony/Philips Digital Interface Format (S/PDIF) communication interface and/or cable and/or a Toshiba Link (TOSLINK) cable. In some examples, the digital I/O 111b comprises a High-Definition Multimedia Interface (HDMI) interface and/or cable. In some examples, the digital I/O 111b includes one or more wireless communication links comprising, for example, a radio frequency (RF), infrared, WiFi, Bluetooth, or another suitable communication protocol. In certain examples, the analog I/O 111a and the digital 111b comprise interfaces (e.g., ports, plugs, jacks) configured to receive connectors of cables transmitting analog and digital signals, respectively, without necessarily including cables.

As shown in FIG. 1C, the playback device 110a can also include an analog source component 116. In various examples, the analog source component 116 can be integrated into the same housing or operably coupled to other components while itself positioned in a separate housing or enclosure. The analog source component 116 can be, for example, any suitable component or set of components configured to facilitate playback of analog media content such as vinyl records, magnetic tape cassettes, or other such analog content. In some examples, the analog source component 116 can take the form of a turntable-style record player (e.g., including a rotatable platter and a tonearm carrying a cartridge and needle). As described in more detail elsewhere herein, the analog source component 116 can be used to enable playback of physical, analog media content (e.g., vinyl LPs) while also providing additional functionality as compared to conventional analog playback devices.

Additionally, the playback device 110a can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some examples, the local audio source 105 includes local music libraries on a smartphone, a computer, a networked-attached storage (NAS), and/or another suitable device configured to store media files. In certain examples, one or more of the playback devices 110, NMDs 120, and/or control devices 130 comprise the local audio source 105. In other examples, however, the media playback system omits the local audio source 105 altogether. In some examples, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some examples, the playback device 110a optionally includes one or more microphones 115 (e.g., a single microphone, a plurality of microphones, a microphone array) (hereinafter referred to as “the microphones 115”). In certain examples, for instance, the playback device 110a having one or more of the optional microphones 115 can operate as an NMD configured to receive voice input from a user and correspondingly perform one or more operations based on the received voice input.

In the illustrated example of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some examples, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some examples, the operations further include causing the playback device 110a to send audio data to another one of the playback devices 110a and/or another device (e.g., one of the NMDs 120). Certain examples include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some examples, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some examples, for instance, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated example of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some examples, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain examples, the network interface 112d includes the wired interface 112f and excludes the wireless interface 112e. In some examples, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some examples, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain examples, one or more of the audio processing components 112g can comprise one or more subcomponents of the processors 112a. In some examples, the electronics 112 omits the audio processing components 112g. In some examples, for instance, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some examples, for instance, the amplifiers 112h include one or more switching or class-D power amplifiers. In other examples, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain examples, the amplifiers 112h comprise a suitable combination of two or more of the foregoing types of power amplifiers. Moreover, in some examples, individual ones of the amplifiers 112h correspond to individual ones of the transducers 114. In other examples, however, the electronics 112 includes a single one of the amplifiers 112h configured to output amplified audio signals to a plurality of the transducers 114. In some other examples, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some examples, the transducers 114 can comprise a single transducer. In other examples, however, the transducers 114 comprise a plurality of audio transducers. In some examples, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain examples, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

The playback device 110a can also optionally include display components 112k that are configured to play back visual content (e.g., video), either accompanying audio playback or independently of any audio playback. In various examples, these display components 112k can include video display elements and associated electronics. Examples of suitable display elements include a display screen (e.g., liquid crystal display (LCD), light-emitting diode (LED) display, organic LED (OLED) display, etc.), a projector, a heads-up display, a wearable display (e.g., smart glasses, a smart watch, etc.), or any other suitable display technology that can play back visual content for viewing by one or more users. In some examples, the playback device 110a includes the display components 112k integrated within the same housing, for example in the case of a smart television or other such device. Additionally or alternatively, the playback device 110a can include display components 112k that are separate from but communicatively coupled to other elements of the playback device. For example, the playback device 110a can take the form of a soundbar that is communicatively coupled (e.g., via wired or wireless connection) to a television or other display component. In some examples, the playback device 110a can take the form of a dongle, set-top box, or other such discrete electronic component that can be communicatively coupled to a video display component such as a television, whether via a wired or wireless connection.

By way of illustration, SONOS, Inc. presently offers (or has offered) for sale certain playback devices including, for example, a “SONOS ONE,” “MOVE,” “PLAY:5,” “BEAM,” “PLAYBAR,” “PLAYBASE,” “PORT,” “BOOST,” “AMP,” and “SUB.” Other suitable playback devices may additionally or alternatively be used to implement the playback devices of example examples disclosed herein. Additionally, one of ordinary skilled in the art will appreciate that a playback device is not limited to the examples described herein or to SONOS product offerings. In some examples, for instance, one or more playback devices 110 comprises wired or wireless headphones (e.g., over-the-ear headphones, on-ear headphones, in-ear earphones). In other examples, one or more of the playback devices 110 comprise a docking station and/or an interface configured to interact with a docking station for personal mobile media playback devices. In certain examples, a playback device may be integral to another device or component such as a television, a lighting fixture, or some other device for indoor or outdoor use. In some examples, a playback device omits a user interface and/or one or more transducers. For example, FIG. 1D is a block diagram of a playback device 110p comprising the input/output 111 and electronics 112 without the user interface 113 or transducers 114.

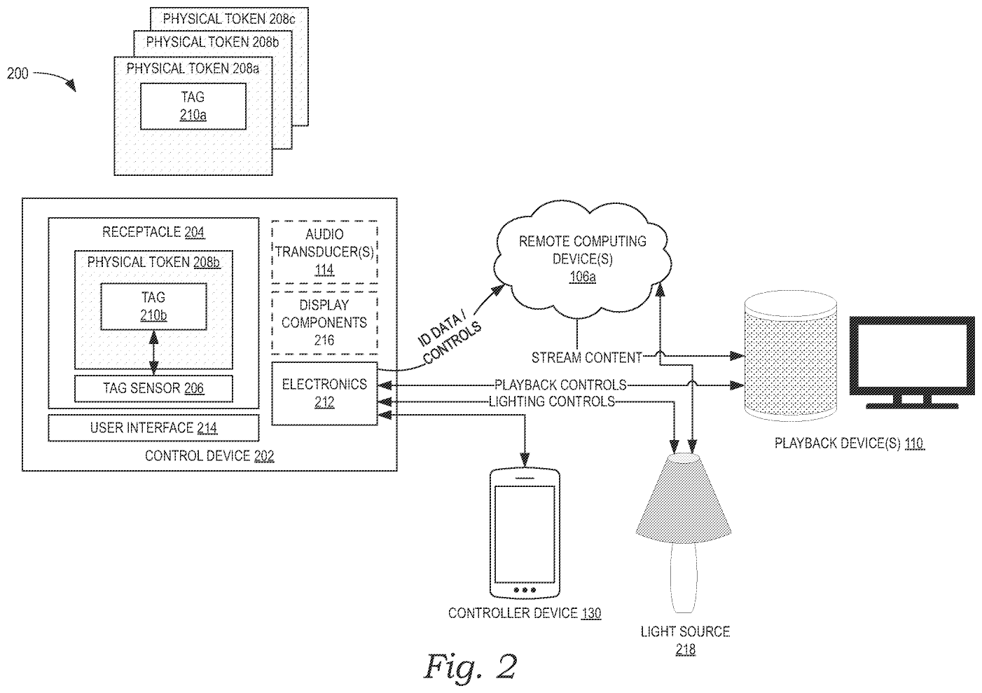

FIG. 1E is a block diagram of a bonded playback device 110q comprising the playback device 110a (FIG. 1C) sonically bonded with the playback device 110i (e.g., a subwoofer) (FIG. 1A). In the illustrated example, the playback devices 110a and 110i are separate ones of the playback devices 110 housed in separate enclosures. In some examples, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some examples, for instance, the playback device 110a is full-range playback device configured to render low frequency, mid-range frequency, and high frequency audio content, and the playback device 110i is a subwoofer configured to render low frequency audio content. In some examples, the playback device 110a, when bonded with the first playback device, is configured to render only the mid-range and high frequency components of a particular audio content, while the playback device 110i renders the low frequency component of the particular audio content. In some examples, the bonded playback device 110q includes additional playback devices and/or another bonded playback device. Additional playback device examples are described in further detail below with respect to FIGS. 2A-2C.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some examples, the NMD 120a is configured as a media playback device (e.g., one or more of the playback devices 110), and further includes, for example, one or more of the audio components 112g (FIG. 1C), the amplifiers 114, and/or other playback device components. In certain examples, the NMD 120a comprises an Internet of Things (IoT) device such as, for example, a thermostat, alarm panel, fire and/or smoke detector, etc. In some examples, the NMD 120a comprises the microphones 115, the voice processing components 124, and only a portion of the components of the electronics 112 described above with respect to FIG. 1B. In some examples, for instance, the NMD 120a includes the processor 112a and the memory 112b (FIG. 1B), while omitting one or more other components of the electronics 112. In some examples, the NMD 120a includes additional components (e.g., one or more sensors, cameras, thermometers, barometers, hygrometers).

In some examples, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other examples, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated example, the control device 130a comprises a smartphone (e.g., an iPhone™, an Android phone) on which media playback system controller application software is installed. In some examples, the control device 130a comprises, for example, a tablet (e.g., an iPad™), a computer (e.g., a laptop computer, a desktop computer), and/or another suitable device (e.g., a television, an automobile audio head unit, an IoT device). In certain examples, the control device 130a comprises a dedicated controller for the media playback system 100. In other examples, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some examples, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated example, the user interface 133 comprises a display presented on a touch screen interface of a smartphone (e.g., an iPhone™, an Android phone). In some examples, however, user interfaces of varying formats, styles, and interactive sequences may alternatively be implemented on one or more network devices to provide comparable control access to a media playback system.

As described in more detail below, in various examples the control device 130 can be configured to control or otherwise interact with video playback via a playback device 110. In some examples, the control device 130 can be used to control video playback via the playback device (e.g., selecting video content or other such media content for playback). Additionally or alternatively, the control device 130 can be used to present supplemental content to the user during video playback via the playback device 110. For example, the user may initiate, via the control device 130, playback of a television show on a playback device 110 (e.g., a smart television). During playback of the television show, supplemental content (e.g., other recommended shows, cast list, friends' ratings, etc.) can be presented to the user via the interface 133 of the control device 130. In some examples, multiple control devices 130 can be used by the same or different users within the same environment to control the same playback device(s) 110. Moreover, the same or different supplemental content can be provided to those user(s) via the corresponding control devices 130.

The one or more speakers 134 (e.g., one or more transducers) can be configured to output sound to the user of the control device 130a. In some examples, the one or more speakers comprise individual transducers configured to correspondingly output low frequencies, mid-range frequencies, and/or high frequencies. In some examples, for instance, the control device 130a is configured as a playback device (e.g., one of the playback devices 110). Similarly, in some examples the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some examples, two or more of the microphones 135 are arranged to capture location information of an audio source (e.g., voice, audible sound) and/or configured to facilitate filtering of background noise. Moreover, in certain examples, the control device 130a is configured to operate as playback device and an NMD. In other examples, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Examples of Media Playback Control Using Physical Tokens

FIG. 2 illustrates an example media playback system 200 for control of media playback that involves the use of one or more physical tokens. As noted previously, the use of physical tokens for controlling media playback (and/or controlling other functions associated with a media playback system) can provide particular benefits to users. Certain users may prefer the aesthetics and tactile experience associated with handling physical tokens for playback control, as opposed to using a software application or voice input to control playback. Additionally, for vision-impaired users, children who may not be able to operate a control application, or other such users, physical tokens can provide a simplified and streamlined approach to controlling media playback. Moreover, as described in additional detail below, the use of physical tokens can enable novel functionality, such as dynamically modifying generative audio via physical token placement, creating or updating playlists on the fly, controlling a moodscape of a room (e.g., a soundscape in addition with lighting parameters), and a number of other use cases (e.g., interactive retail, restaurant, and collaborative classroom use).

As shown in FIG. 2, the media playback system 200 includes a control device 202, which can be used to select and control playback of media content (e.g., audio and/or video) via one or more playback device(s). The control device 202 can be in communication with one or more remote computing devices 106, which may in turn communicate with one or more playback device(s) 110 within the environment. In various examples, the remote computing devices 106 can include devices associated with media content providers (e.g., SPOTIFY, PANDORA, etc.), voice assistant services (e.g., AMAZON Alexa, GOOGLE Assistant, etc.), lookup servers that can identify particular media content based on identifiers received from the control device 202, etc.), and/or any other suitable remote computing devices.

The control device 202 can receive input in the form of one or more physical tokens 208, each of which carries a corresponding tag 210. As described in more detail elsewhere herein, the physical tokens 208 can be removably engaged with a receptacle 204 of the control device 202, and in the engaged position a tag sensor 206 of the control device 202 is configured to interact with the tag 210 carried by the physical token 208. In some embodiments, the tag 210 includes an identifier or other data that can be used to match a specified container of digital content. In the arrangement shown in FIG. 2, a plurality of different physical tokens 208a-208c can be provided, each having a different corresponding tag 210a—c carried thereby. When the control device 202 engages with a particular physical token 208b, the tag sensor 206 extracts the corresponding identifier from corresponding the tag 210b. This identifier (shown as “ID data” in FIG. 2) can then be transmitted to the remote computing device(s) 106a, which can then look up the particular digital content corresponding to the identifier and stream that content to the playback device 110 for playback. If the user places a different physical token 208c on the control device 202, a different identifier can be extracted from the corresponding tag 210c and used to request playback of different corresponding digital content stored via the remote computing device(s) 106a. If the user interacts with the playback device 110 for playback control (e.g., pressing pause, skip, etc.,) those controls can be used to modify playback of the streamed content.

Using physical, analog objects to identify corresponding digital content can provide several advantages while maintaining the aesthetic and experiential aspects of interacting with physical media. For example, a user may create a custom “mixtape” by selecting her own desired arrangement of audio tracks. This arrangement can be stored at the remote computing device(s) 106 and associated with a particular identifier that corresponds to a tag 210 carried by a physical token 208. Since the tag 210 encodes only a particular identifier, and not the audio itself, the user can dynamically modify the arrangement of digital content corresponding to that identifier. As such, the particular audio played back in response to placing the physical token 208 into engagement with the control device 202 can vary over time based on the user's selections. In some embodiments, the identifier can be used to retrieve supplemental content associated with a particular album or other audio content (e.g., extra artist interviews, exclusive tracks, etc.). Additionally or alternatively, the identifier can be use to obtain locally generated content.

In some examples, the user can interact with the physical token 208 in a manner similar to those of a record player. For example, the physical token 208 can be rotatable such that playback can be initiated by nudging the physical token 208 to begin rotating, playback can be paused by touching the physical token 208 with enough friction to stop rotation, etc. Additional options include skipping tracks by quickly rotating the physical token 208 in a forward direction, or rewinding/repeating by quickly rotating the physical token 208 in a backward direction. Such an approach can provide the user with a tactile experience similar to those of a record player, while allowing access to the vastly larger library of available media accessible via the remote computing device(s) 106a.

Optionally, the control device 202 can take the form of an audio playback device, in which case the control device 202 may include audio transducers 114 and corresponding electronic components to play back audio. In some examples, the control device 202 can take the form of a video playback device, in which case the control device 202 can include display components 216 configured to output a visible display (e.g., a screen, projector, etc.).

The electronics 112 can optionally include any of the electronics 112 described above with respect to FIG. 1C, such as one or more processors, memory, software components, audio processing components, audio amplifiers, power components, and/or a network interface. The electronics 112 can also include power components, such as an energy storage component (e.g., a rechargeable battery), a wireless charging component (e.g., a charging coil configured to receive wireless power from an adjacent charging base, from a nearby playback device, or from any other suitable wireless power transmitter; a charging coil configured to wirelessly charge devices placed thereon (e.g., a user's smartphone, tablet, etc.).

The electronics 112 can also include one or more processors configured to perform operations based on instructions stored in memory. These operations can include, for example, transmitting or receiving data via a network interface (e.g., a wired or wireless LAN or WAN connection) to other computing devices or playback devices. In at least some examples, the playback device 110 include one or more microphones (e.g., the playback device 110 can include a network microphone device or be integrated into a network microphone device). In some examples, the control device 202 and/or the playback device 110 can be configured to enable voice calls, and in some instances a physical token can be used to initiate voice calls to designated recipients.

Although several examples illustrate the control device 202 communicating (e.g., via a network interface) with separate and discrete playback device(s) 110, in some examples, playback device 110 and the control device 202 can be integrated into the same housing or enclosure, thereby forming a single playback device. For example, in each case in which audio content is described as being played back via the playback device(s) 110, an alternative configuration involves playing back that audio content via the transducer(s) 114 and/or playing back video content via the display components 216 of the control device 202, in which case the separate playback device(s) 110 are optional. As also shown, the control device 202 and/or the playback device(s) 110 can also be in communication with a controller device 130 (e.g., a smartphone, tablet, laptop, etc.), which can provide playback controls, media selection, and other inputs.

As shown in FIG. 2, the control device 202 can include a receptacle 204 and a tag sensor 206. In operation, a physical token 208 can be removably received within, on, or about the receptacle 204 (i.e., the physical token 208 can be placed in an engaged position with respect to the receptacle 204). Once in the engaged position, the tag sensor 206 of the control device 202 can interact with the tag 210 carried by the physical token 208 to extract data (e.g., an identifier) that can be used for selection of media content for playback. For example, the tag 210b of the physical token 208b can include an identifier associated with particular media content (e.g., a particular song, album, playlist, television show, etc.). Using this identifier, the control device 202 can transmit a request (e.g., via a wide area network or other suitable communications network) to the remote computing device(s) 106 for playback of that particular media content. As such, the control device 202 can be configured to extract an identifier by sensing the tag 210b of the physical token 208b, and this identifier can be used to request and play back corresponding digital content that is stored remotely. In this configuration, various arrangements of media content can be stored digitally while being represented and identified using physical tokens, which can take any suitable form factor (e.g., optionally mimicking vinyl records, cassette tapes, etc.).

In some instances, the control device 202 can transmit an identifier (e.g., an alphanumeric string) that can be used by the remote computing device(s) 106 to lookup particular media content, which can then be retrieved for playback via one or more playback device(s) 110. In other examples, the media content is streamed from a local source (e.g., user device, NAS, a playback device) rather than from the remote computing device(s) 106. Among examples, the identifier extracted from tag can be a unique identifier associated with a cloud-based (or other) table. For example, the particular identifier can be sent to remote computing devices 106 for lookup, retrieval, and playback. Additionally or alternatively, the identifier extracted from the tag 210 can be a URL or URI indicating the location from which particular media content can be retrieved. In some examples, the identifier extracted from the tag 210 corresponds to a radio station or dynamic playlist associated with a particular entity (e.g., NPR's “Morning Becomes Eclectic”), podcast feed that plays back most recent episodes, a particular individual (e.g., a playlist curated by an artist or DJ), etc. Other data can likewise be embedded in the tag 210. Examples include generative audio content models, generative audio engines, generative audio input components (e.g., seeds, stems, etc.), or other such data that can be used to control media playback.

Optionally, when a user removes the physical token 208b from the receptacle 204, playback of the corresponding media content can terminate. Alternatively, playback of the media content can continue until actively terminated by a user. After removing one physical token 208b from the receptacle 204, when a user places another physical token (e.g., physical token 208a or 208c shown in FIG. 2) into an engaged position with respect to the receptacle 204, the corresponding tag carried by that physical token can be read by the tag sensor 206 and the corresponding media content can be identified and played back. In this manner, a user can select and control playback of media content by placing physical tokens into engagement with the receptacle 204 of the control device 202 and by removing physical tokens out of engagement with the receptacle 204.

In various implementations, one or more passive feedback elements can be incorporated into the token 208 that can be activated in response to proximity to the control device 202 (e.g., an RF receiver coil that lights up an LED when the tag(s) 210 are brought into proximity to the receptacle 204).

In some examples, a user can place more than one token 208 into engagement with the control device 202 simultaneously. For instance, a user may place one token 208a corresponding to a first album and a second token 208b corresponding to a second album into engagement with the control device 202 simultaneously (e.g., both tokens 208a and 208b can be engaged with the receptacle 204). The tag sensor 206 can read the data from each of the corresponding tags 210a and 210b, and in response transmit an appropriate request to the remote computing device(s) 106. Among examples, this request can cause the remote computing device(s) 106 to generate a playlist that includes both the first album and the second album. Additionally or alternatively, this request can cause the remote computing device(s) to generate a playlist of media content that are based on the selected first and second album (e.g., media content in the same genre, by the same or similar artists, having similar or overlapping musical characteristics, etc.). In some instances, such multi-token requests can be handled locally (e.g., the media playback system 200 can make a determination based on data obtained from each of the tokens 208 and play back appropriate media content, whether the content itself is obtained locally or via the remote computing device(s) 106).

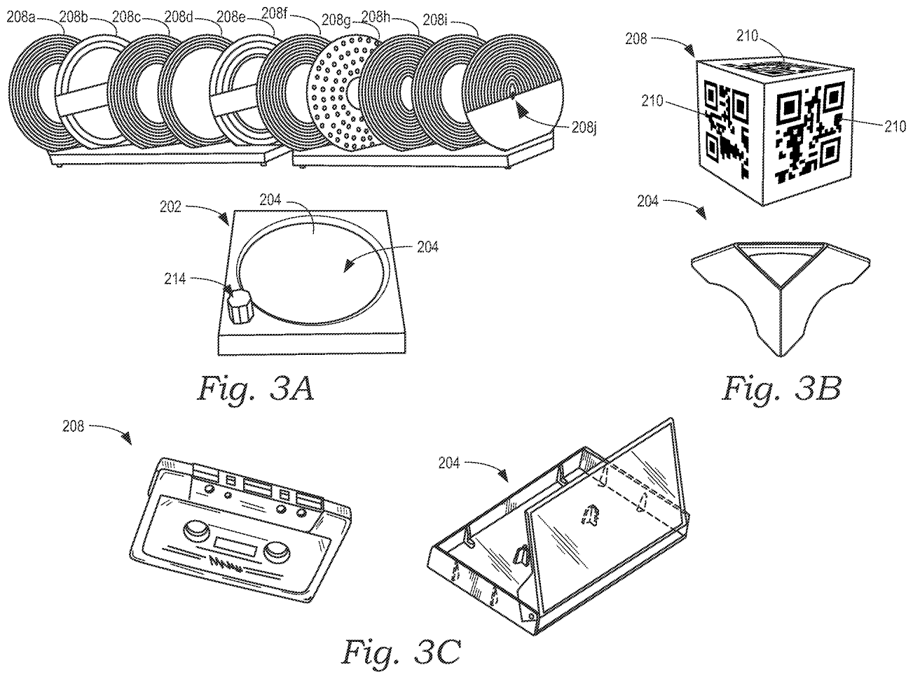

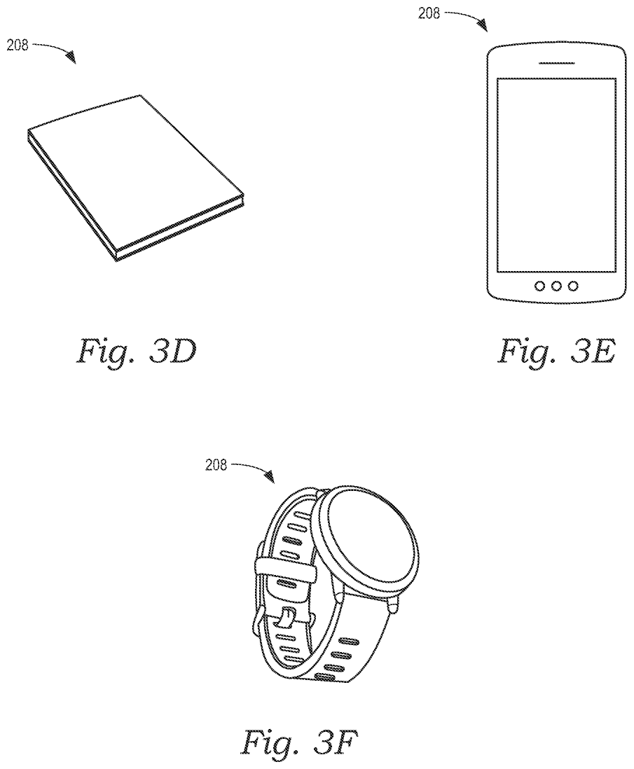

In various examples, the physical token 208 can take any suitable shape, size, and form. For instance, a physical token 208 can be any suitable object, device, or portion thereof, and may be sized and configured to be held by a user for ease of placement into and out of engagement with the receptacle 204. FIGS. 3A-3F illustrate example physical tokens for use with corresponding control devices having suitable receptacle(s). In the example shown in FIG. 3A, the control device 202 takes the form of a platter having an indentation defining the receptacle 204. A plurality of physical tokens 208a-208j are shown in the form of vinyl record-like objects, which can be disc-shaped objects, optionally having grooves similar to a conventional vinyl record. In some instances, the grooves themselves can be embedded with identification portions that can be read by the control device 202 and to determine associated media content. As shown in FIG. 3A, a lower portion of the token 208 can include a visual indication (e.g., name, album art, playlist art/insignia) of the media content associated with the object.

One or more accessibility features (e.g., braille dots) can provide an alternate way of identifying the associated media content for visually impaired users. In some examples, the accessibility features themselves are used as the tag 210 corresponding to the target media. For instance, a reader device (e.g., the control device 202) may be configured to detect the braille dots (or another accessibility feature) on the physical token 208 and identify the corresponding text. Based on the identified text, the media content can be retrieved from the remote computing device(s) 106 for playback.

While in the illustrated example of FIG. 3A, the token 208 has a round, disc format reminiscent of perhaps a vinyl LP, a compact disc, or a DVD, in various examples the physical token 208 can have a form factor that generally corresponds to other analog or digital media including, for instance, a cassette tape (FIG. 3C), 8-track, VHS/Betamax cassette, floppy disk, etc. In some examples, the physical token 208 can have a form factor unrelated to media altogether including, for instance, a cube (FIG. 3B), a cylinder, a triangle, a cone and/or another polygonal shape, a button (e.g., a washable button) or another article of clothing. In each instance, a corresponding receptacle 204 can be provided that is configured to removably receive the physical token 208 thereon, therein, or otherwise engage with the physical token 208. For example, as shown in FIG. 3B, the cube-like token 208 can be placed within a receptacle 204 in the form of a base, while FIG. 3C illustrates a receptacle 204 having a form factor reminiscent of a cassette tape case. In another example, a token 208 can take the form of an analog text source (e.g., a book, magazine, etc.). Optionally, when such a physical token 208 is placed into engagement with a control device 202, an audio version of the text can be played back (e.g., a corresponding audiobook can be identified and played back based on data extracted from a tag 210 carried by the book-like physical token 208). In some examples, a user may place a first physical token having a first shape (e.g., the token 208 of FIG. 3A) on or near the receptacle 204, causing the corresponding media to play back. Subsequently (e.g., after removing the first physical token) the user may place a second physical token having a second, different shape (e.g., the token 208 of FIG. 3C) or near the receptacle, causing the corresponding media to play back. In this scenario, the receptacle 204 is capable of identifying media associated with the first physical token and the second physical token regardless of the different shape, sizes, form factors, etc. associated with the first and second physical tokens, respectively.

In some examples, the various physical form(s) of the token 208 correspond to various output modalities (e.g., a cylinder could control sound, a cone could set the lighting, and a cube could select the room), and could thus be simultaneously used to control multiple aspects of a space at the same time.

In some examples, the token 208 comprises a device comprising a tag 210 (e.g., an NFC tag) such as a smartphone (FIG. 3E), smart wearable (FIG. 3F) (e.g., smartwatch, headphone), smart locator (e.g., AirTag, Tile), etc. In some examples, placing the device on or near the control device 202 will launch a personalized playlist, perhaps one that is contextually aware. In some examples, placing the device on or near the tag sensor 206 of the control device 202 can cause playback of what is currently playing on the user's device. In certain examples, placing the smartphone on or near the tag sensor 206 can prompt the user to open a digital wallet with recent event tickets (e.g., music performance, movie, sporting event) and selecting one of the tickets can cause playback of media associated with the event. In other examples, the physical ticket itself can have an identifier or code that launches associated media, rather than a device.

In some examples, placing both a passive token (e.g., a cube with a QR code (FIG. 3B), a disc-like object with an embedded NFC coil, etc.) and a token-enabled device (e.g., a smartphone, smartwatch, etc.) on or near the control device 202, either simultaneously or sequentially, can cause playback of a particular track, album, station, media content, etc. related to the identifier on the token, but personalized for the user. For instance, a token associated with a “chill” station may cause playback of a generic chill playlist/station, but a subsequent (or prior) tap of the user's smartphone will cause the playlist to be tailored to the particular user based on listening history, preferences, etc.

The tag 210 carried by the physical token 208 can take a number of different forms. Examples include optically readable tags (e.g., QR code, barcode, visible text, infrared ink, etc.) or electromagnetically readable tags (e.g., near-field communication (NFC) tags, radiofrequency identification (RFID) tags, magnetic elements that generate or respond to magnetic fields, etc.), and any other device, component, or structure that can store an identifier or other data in a manner detectable by an appropriate tag sensor 206. In some examples, a single token 208 can include multiple tags 210 that are readable by the tag sensor 206 in different orientations or configurations. For example, in the example shown in FIG. 3B, a cube-like token 208 includes tags 210 in the form of QR codes printed on each face. An optical tag sensor 206 (e.g., a camera) can view a particular face of the cube 208 depending on its orientation with respect to the receptacle 204. Accordingly, by changing the orientation of the token 208 with respect to the receptacle 204, a different tag 210 can be read, and accordingly different media content can be played back. In various examples, different tags 210 can be presented by changing the position and/or orientation of the token 208 with respect to the receptacle 204, such as rotating, translating, sliding, tilting, tapping, or otherwise changing the relative orientation of the token 208 and the receptacle 204.

In various examples, the tag sensor 206 can be any suitable device, component, or structure that is configured to interact with the tag 210 carried by the physical token 208 to extract an identifier or other data encoded in the tag 210. Examples of suitable tag sensors 206 include optical sensor(s) (e.g., a camera or other image-capture device, whether still or video) and electromagnetic sensors (e.g., NFC coil, RFID transceiver, inductive coupling sensor, etc.).

In some instances, the tag 210 can include physical features of the token 208, such as surface contours or texture, size, shape, weight, color, or any other parameter or feature of the physical token 208 that can convey data. For example, rather than a vinyl record that has audio encoded in grooves of the record, a vinyl record can have encoded therein an identifier (e.g., a numerical, alphabetic, or alphanumeric code or other such identifier) that can be used to retrieve digital content from remote computing device(s) 106a.

As noted above, the control device 202 can include a receptacle 204 configured to removably engage with one or more physical tokens 208. In various examples, the receptacle can take any suitable form, which may depend on the particular configuration and form factor of the token(s) 208. For instance, the receptacle 204 can be a designated portion of a surface of the control device 202 onto which a token 208 can be placed. The receptacle 204 can optionally include an aperture, opening, recess, groove, indentation, or other such feature configured to at least partially receive a physical token 208 therein. In some instances, the receptacle 204 defines an opening with a shape that corresponds to the physical token 208 (e.g., a square-shaped opening configured to receive a cube-shaped token 208). As noted above, the receptacle 204 can mimic analog media components, such as a platter-like receptacle 204 for receiving vinyl record-like tokens 208 (FIG. 3A), a cassette tape case-like receptacle 204 for receiving a cassette tape-like token 208 (FIG. 3C), or other such configurations.

In some examples, the control device 202 is a standalone device that interacts with the physical token 208 with a tag 210 and causes playback of target media by a nearby (or another suitable) playback device 110. In some examples, the control device detects the closest playback device(s) 110 and automatically begins playback on the detected device(s) 110 when a physical token 208 with an appropriate tag 210 is placed into engagement with the receptacle 204. The determination of closest playback device(s) 110 can be performed, for instance, via a particular sensor modality (e.g., acoustic detection, ultrawideband (UWB) localization, Bluetooth or another IEEE 802.15 network, wireless power transfer, NFC tap, etc.), a combination of sensor modalities, and/or manual indication. In some examples, the closest playback device 110 may be one or more wearable devices (e.g., headphones, earbuds, AR glasses, VR headsets). Additional details regarding determining locations of various devices and/or users within an environment are described in Appendix A, which is included herewith.

In some examples, a control device 202 can be assigned to a particular device or zone on a permanent or semi-permanent basis, rather than playback being automatically routed to the closest playback device. In some examples, the control device 202 is located in an automobile or other vehicle. Additionally or alternatively, if the particular media content identified by a token 208 is associated with home theatre or multi-object music (e.g., Atmos music), the control device 202 can automatically select the most suitable zone (e.g., a home theatre or other Atmos-capable devices) to play back the media content, rather than simply selecting the nearest playback device. If the nearest (or most suitable) playback device is already playing back media content, then the control device 202 may optionally select a different playback device to play back the content derived from the physical token 208. Alternatively, the control device 202 may override the currently playing media content on the nearest (or most suitable) device(s) and initiate playback of the content derived from the physical token 208.

In some instances, playback of the media content may be restricted to only certain designated playback devices (e.g., a token 208 can only control playback in a child's bedroom), and/or may be restricted to exclude certain playback devices (e.g., a token 208 cannot initiate playback in a home office). Such restrictions can be applied at the control device 202 level, or the restrictions can be specific to particular tokens 208.

As discussed above, the tag 210 can include an NFC tag, RFID tag, QR code, bar code, etc. If the tag 210 comprises an NFC tag, the tag can encode a unique ID associated with a cloud-based (or other) table (e.g., an ID sent to a cloud-based server for lookup to identify media content). In some instances, an NFC tag (or other suitable tag) can store readable/writable data (e.g., the tag can store a URI where the media can be retrieved directly via the playback device(s) 110, or the tag can include other data, such as a generative audio algorithm or engine).

Referring back to FIG. 2, the control device 202 can also communicate with one or more light sources 218. Such light sources 218 can be “smart” lights that are configured to be controlled via the control device 202, for example turning on and off, adjusting brightness levels (brighter, darker), changing color output, outputting a particular light pattern, etc. In some instances, a particular physical token 208 can include data encoded via its tag 210 that causes the media playback system 200 to adjust a parameter of the light source(s) 218. In various examples, the control device 202 can transmit a request to the light source(s) 218 (e.g., over a local area network), or the control device 202 can transmit data to the remote computing device(s) 106, which in turn can transmit instructions to the light source(s) 218 to modify one or more lighting parameters. In one example, the control system can identify an available light source 218, which may be based at least in part on distance between the light source(s) 218 and the control device 202 and/or playback device 110. For instance, the light source 218 can be selected by detecting one or more light sources available to the media playback system, determining a distance between at least one of the one or more available light sources and at least one of the control device 202 and the audio playback device 110, and selecting one or more light source(s) 218 from the one or more available light sources based on the determined distance between the light source 218 and at least one of the control device 202 and the audio playback device 110). After identifying and/or selecting one or more light source(s) 218, the lighting output can be adjusted based on data obtained via the physical token 208. Using this approach, lighting scene data can be provided via tokens 208, optionally in conjunction with audio content. This can allow a user to control the visual mood of a space using tokens 208, and may facilitate a single token 208 that corresponds to a “moodscape,” in which appropriate audio content and lighting parameters are selected to achieve the desired mood (e.g., upbeat dance party, calm study session, etc.).

In some examples, the user can modify playback by physically manipulating the physical token 208b to change the orientation of the physical token 208b and/or the corresponding tag 210b with respect to the receptacle 204 and/or the tag sensor 206. For example, moving the token in a certain manner (e.g., azimuthal rotation of a disc-shaped token 208 in a clockwise or counterclockwise direction, at a particular speed, etc.), the movement can be detected (e.g., via the tag sensor 206 or other sensor(s) of the control device 202) and a corresponding playback control can be transmitted to the remote computing device(s) 106 and/or to the playback device(s) 110. Example playback controls can include commands to pause, skip, fast-forward, rewind, increase or decrease volume, or any other suitable command. Such commands can also be provided by a user interface portion 214 of the control device 212, which can include any suitable configuration of knobs, buttons, dials, touch-sensitive surfaces (e.g., a touchscreen), etc.

In some examples, the user interface portion 214 can include one or more user input components (e.g., knob, button, touch-sensitive surface, etc.) that, when activated, causes a currently playing media item to be assigned to the tag 210 of the physical token 208 then being sensed by the tag sensor 206. In this manner, a user may be able to “overwrite” data stored via the tag 210 of the physical token 208, thereby dynamically updating the particular media content associated with the physical token 208. According to some examples, a user may initiate playback of media content (e.g., song, podcast, music and/or video playlist, radio station, video media such as television show or movie) while a physical token 208 is placed into engagement with the receptacle 204. With a particular predetermined input sequence (e.g., a triple click of an input device in user interface portion 214), the physical token 208 can be reassigned to the currently played back media content, rather than previously assigned content. In certain examples, the physical token 208 can be used in a gaming context in which the user may store or otherwise assign data associated with the gaming to the tag 210 carried by the token 208. For instance, a user may be playing a game with a particular game state, and she may wish to store the particular game state for fast, convenient resumption at a later time.

In some examples, the control device 202 can receive more than one physical token 208 at a time and the system can correspondingly a) place in a queue of a playback device(s) all the media content corresponding to the individual physical tokens or b) create a combination of the media content in a single playlist, station, or queue. For example, if the user places three tokens corresponding to the Beatles' White Album, Marvin Gaye's What's Going On? and Miles Davis's Kind of Blue, respectively, the system can correspondingly a) place all three albums in the queue of a particular playback device (or group of devices) or b) playback a playlist or station that is created based on the individual albums and/or tracks of the three albums.

In some instances, the objects may point to media content from three different media services, in which the user may only subscribe to two, one or none. If the user subscribes to two different media services, then the media playback system 200 can select one of the services to use and identify the corresponding media content associated with the physical token 208 pointing to the unavailable service. If the user subscribes to only one of the media services, then the system 200 can select from that service (or another service to which the user is subscribed) the other two media content targets from the unavailable service(s). Finally, if the user is subscribed to none of the services, the system 200 can identify all the media content and select the best media service to which the user is subscribed to fulfill retrieval of the media content. In some examples, if the user is not subscribed to any service, the physical token 208 may grant temporary access to the appropriate services. In other examples, a generative composition based on the unavailable media content (or metadata corresponding thereto) can be algorithmically generated in lieu of (or in combination with) the media content.

As noted above, in some examples the token 208 can be used to control and/or modify the production and playback of generative media content. For example, data extracted from a tag 210 of a particular token 208 can correspond to a particular generative media engine, generate media content model, one or more inputs to a generative media engine (e.g., stems, seeds, etc.), or any other component or parameter associated with generative media content. In some instances, different tokens 208 can correspond to different features that can be incorporated into a generative media engine simultaneously, allowing a user to mix and match moods, features, etc. For instance, a user may have a “focus music” token and a “cafe ambiance” token, each of which can then serve as input parameters for a generative media content engine. The resulting generative media content can be based on these various parameters (e.g., the generative media content engine can produce audio having features of focus-enhancing audio and a cafe ambiance). In some instances, a token 208 corresponding to a particular artist, album, track, etc. can be read by the control device 202 and used as an input for a generative media engine rather than playing back particular pre-selected audio content. For instance, placing a physical token 208 corresponding to “Michael Jackson” into engagement with the control device 202 may cause generative media content to be produced and played back that has characteristics reminiscent or otherwise based on Michael Jackson's repertoire. Additional details regarding production and playback of generative media content can be found in commonly owned International Patent Application Publication No. WO2022/109556, titled “Playback of Generative Media Content,” which is hereby incorporated by reference in its entirety.

In some examples, the playback device 110 is configured to receive both analog media and a physical token 208 with a tag 210. For instance, the playback device 110 can have a turntable form factor and be configured to playback vinyl LPs but can also have (e.g., on or within the turntable platter) an integrated tag sensor 206 configured to identify physical tokens 208 having a tag 210 as discussed above. In some examples, the playback device 110 can identify media associated with the physical token 208 and cause playback on a) the playback device 110 itself, b) one or more other playback devices (excluding the playback device 110), and/or c) the playback device 110 and one or more other playback devices, either grouped together (such that each device plays back the same media content) or bonded (such that individual devices are assigned and play back one or more individual channels of media content).

In some examples, the tag 210 carried by the token 208 comprises a link to a non-fungible token (NFT) or other blockchain data. For instance, if a user purchases an NFT corresponding to media content (e.g., musical track or album, video, image), placing the token 208 on or near the receptacle 204 can cause playback and/or display of the corresponding media content. In some instances, some or all of the data stored or associated with the NFT are also stored on or by the token 208. In certain examples, the tag data maintains a one-to-one relationship with the NFT such that if the data on the NFT or associated therewith changes, the tag data is updated accordingly. In this way, a user can have a tangible version of the blockchain token she purchases.

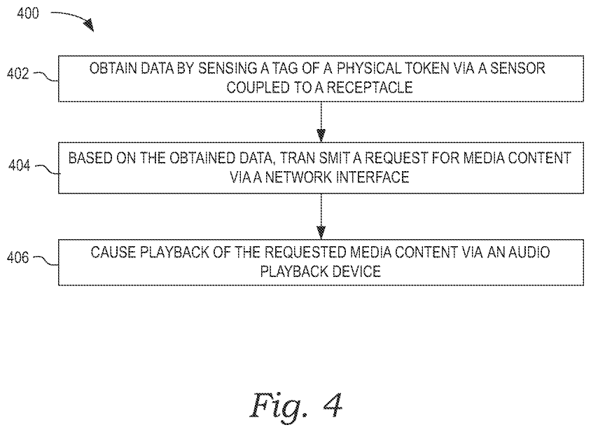

FIG. 4 illustrates an example method in accordance with the present technology. The methods described herein can be implemented by any of the devices described herein, or any other devices now known or later developed. Various embodiments of the methods described herein include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the method 400 and for other processes and methods disclosed herein, the flowcharts show functionality and operation of possible implementations of some embodiments. In this regard, each block may represent a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that stores data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in the figures may represent circuitry that is wired to perform the specific logical functions in the process.

FIG. 4 illustrates an example method for controlling media playback using a physical token. The method 400 begins at block 402, which involves obtaining data by sensing a tag of a physical token via a sensor coupled to a receptacle. For example, as described elsewhere herein, a control device can include a receptacle configured to removably engage with a physical token. In the engaged configuration, the tag sensor of the control device can interact with (e.g., read data from and/or write data to) a tag carried by the physical token. The tag can be an optical tag (e.g., QR code, bar code, visible text or patterns, etc.), an electromagnetic tag (e.g., NFC, RFID, etc.), or any other suitable structure or component, and the corresponding sensor can likewise be an optical sensor (e.g., camera), an electromagnetic sensor (e.g., NFC reader, RFID reader, etc.), or any other suitable sensing device. In some examples, a physical token can include multiple tags, only a subset of which may be read by the sensor of the control device at a given time depending on the position and/or orientation of the token with respect to the control device.

In various examples, the data obtained by sensing the tag can include a URI, a URL, media content metadata (e.g., artist or track name), or a generative media input identifier. In some instances, a control device can obtain data from multiple tags (optionally from multiple tokens) simultaneously or sequentially, and the data from these multiple tags can be used to request particular media content (e.g., playlist, radio station, etc.). The physical token can comprise a plurality of tags, only one of which may be read by the sensor at a given time depending on the orientation of the physical token with respect to the receptacle.

In some examples, a tag can also specify where or how the content plays. For example, a system that supports reading multiple tags could have a location to place a tag indicating which room is selected in combination with another tag that determines the content.

The method 400 continues at block 404, which involves transmitting a request for media content, via a network interface, based on the obtained data. The request for media content can be a request for specific content (e.g., a song, album, audiobook, movie), or the request can take the form of providing one or more inputs for a generative media content engine to produce generative media content. The requested media content can be obtained via remote computing devices and/or via a local media source.

At block 406, the method 400 involves causing playback of the requested media content via one or more playback devices (e.g., a single playback device, two playback devices bonded in a stereo pair, a group of playback devices). In various examples, the particular audio playback device(s) selected for playback can be determined based on location (e.g., selecting the nearest playback device(s)), playback device characteristics (e.g., selecting Atmos-capable devices to play back Atmos content), based on predefined preferences, rules, or restrictions regarding device selection, or any other approach. Optionally, based on the obtained data from sensing the tag, the media playback system can output an indication of the media content to be played back via the audio playback device. The indication can be an audible indication such as a voice output, a visible indication such as an image of an album cover, or any other suitable indication.

### IV. Examples of Spatial Audio Playback Based on Visual Media Content or Objects

As discussed above, physical tokens carrying tags can be used to control playback of media content. This token-based control approach can also be used to enhance the user experience of reviewing media items such as images or videos. For example, particular media items (e.g., visual media items such as images, videos, animation loops such as GIFs, etc.) can serve as tokens carrying tags to control playback of media content. The tags can take the form of separate elements appended to or embedded within the media items, such as optically readable tags (e.g., QR code, barcode, visible text, infrared ink, etc.), or electromagnetically readable tags (e.g., NFC tags, RFID tags, magnetic elements that generate or respond to magnetic fields, etc.), or any other device, component, or structure that can store an identifier or other data in a manner detectable by an appropriate tag sensor. In some implementations, the tag for a particular media item can be the media item itself (or some aspect thereof). For instance, a photograph of a birthday party can be analyzed visually or optically via a sensor device to identify the particular photograph, particular persons or objects in the photograph, or other characteristics of the photograph (e.g., lighting, contrast, saturation, etc.). As another example of a tag in the form of a media item itself, a uniquely meaningful object, like a baby's first pair of shoes, could be sensed and recognized to relive special captured media moments from a child's first year of life.

In operation, a control device (e.g., a dedicated control device, a smartphone, a tablet, a playback device, or any other suitable device) can include a suitable tag sensor (e.g., an optical tag sensor such as a camera, an electromagnetic tag sensor such as an NFC antenna, etc.). The tag sensor can be configured to sense the tag carried by or embedded within the particular media item. After sensing the tag (e.g., identifying the particular media item or characteristics thereof), corresponding audio content can be selected and/or generated for playback while the user views the media item. In some implementations, the audio content can be spatial audio (e.g., audio that includes both lateral and height channels for a more immersive listening experience). Such accompanying spatial audio can be played back via out-loud playback devices in the user's vicinity, thereby providing a dynamic soundtrack to the user's viewing experience. In some cases, spatial audio can be played back via wearable playback devices (e.g., headphones, earbuds, etc.), instead of or in addition to and in synchrony with playback via out-loud playback devices.

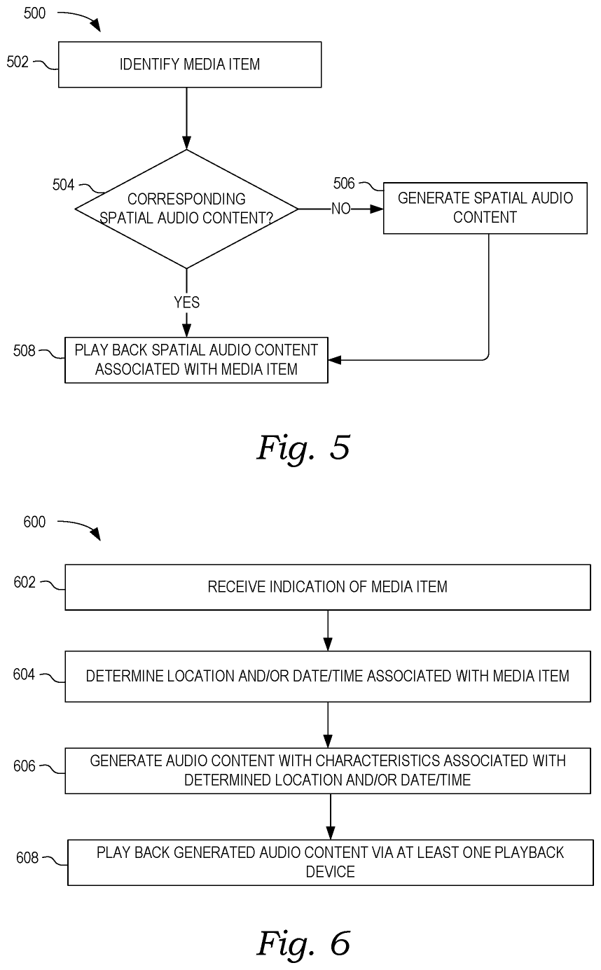

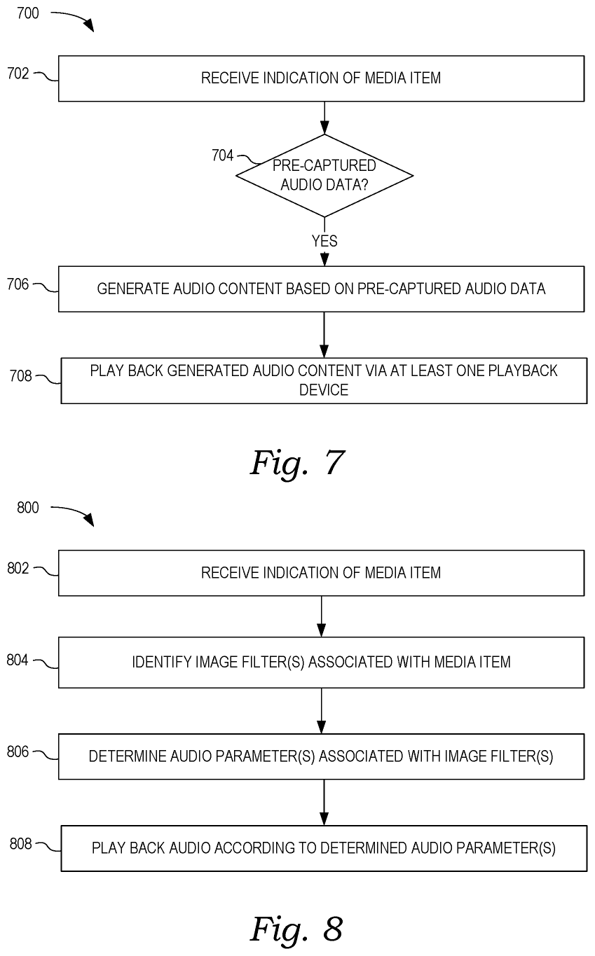

FIGS. 5-9 illustrate various example methods of controlling and modifying audio playback based on identified media item(s). In some implementations, the methods described herein can be performed using at least some components of the media playback system 200 described elsewhere herein. For instance, particular media item(s) (e.g., images, videos, animation loops such as GIFs, etc.) may serve as tokens 208 optionally carrying tags 210 that can be detected via a tag sensor 206 of a control device 202. Among examples, the control device 202 can be a smartphone, tablet, or other mobile computing device and the tag sensor 206 can be an optical sensor (e.g., a camera), an electromagnetic sensor (e.g., NFC reader), or other suitable tag sensor. Additionally or alternatively, the sensor 206 of the control device 202 may directly inspect media items to identify particular media item(s) or to extract features thereof, without the need for a separate tag embedded in or carried by the media item(s). Based on the sensor data obtained via the control device 202, corresponding audio content can be selected and/or generated for playback (e.g., via one or more out-loud playback devices such as playback device 110) to accompany the user's viewing experience. In some cases, the control device 202 includes a receptacle 204 such as a surface on which a media item (e.g., a photograph) can be placed. In at least some implementations, the control device 202 does not include a receptacle 204, and instead the sensor 206 can be moved into position to sense the tag or otherwise inspect the media item.

FIG. 5 is a flow chart illustrating a method 500 for playing back spatial audio content based on an identified media item. The method 500 begins in block 502 with identifying a media item. This identification can involve using a sensor of a control device to read or detect a tag embedded within or carried by the media item. Additionally or alternatively, the identification can involve the sensor of the control device directly inspecting the media item, for example using visual analysis, to identify the media item or characteristics thereof. The identified media item may be linked to pre-existing data, which may be stored locally via the control device or another local device, and/or may be stored via one or more remote computing devices in communication with the control device. For instance, a user may create a photo album with a plurality of individual photos, each of which has a tag or other identifier that can be linked to additional data. The additional data can include, for instance, corresponding audio content to be played back while the user views the media item, characteristics of the media item (e.g., metadata such as geolocation, time/date, etc.). In some implementations, after identifying a particular media item, the control device (or other suitable device of a media playback system) can obtain the additional corresponding data, for instance by querying a local or remote database or other suitable technique. This additional corresponding data can be used to select and/or generate suitable audio content to be played back as audio accompaniment while a user views the media content, as described in more detail below.

In various examples, the media item can be an image, video, a looped animation (e.g., a graphics interchange format (GIF) file), or other visual media item. In at least some instances, the media item is not a visual media item, but may instead be audio content or other non-visual media. In the case of images, the media item can include physically printed images, or images displayed via digital or other display devices.

In various implementations, the sensor includes an optical sensor configured to identify the media item or detect a tag associated with the media item. The optical sensor can include a camera or other light sensor configured to analyze the image, detect a QR code, bar code, fiducial marker, infrared signature, etc. In some examples, the sensor includes an electromagnetic sensor configured to identify an electromagnetic tag associated with the media item, such as an RFID tag, an NFC antenna, etc. In cases in which an image is inspected directly, image recognition can be used to identify a particular photograph, book, object, etc., either to match the object to a pre-existing record or to identify features or characteristics associated with the media item (e.g., identified objects such as people or animals, settings such as beach or mountain scenes, time of day based on lighting, mood, color temperature, or any other suitable characteristic of the media item).

The method 500 continues in decision block 504 to determine whether spatial audio content exists that corresponds to the identified media item. As noted above, the identified media content can be linked to pre-existing corresponding data (e.g., via a unique identifier), which may include spatial audio content. The spatial audio content may be audio content that was originally captured along with the media item (e.g., audio accompanying a video or live photo). Additionally or alternatively, the spatial audio content may be audio content that was selected (by a user or algorithmically) to correspond to the particular media item for accompanying playback. For instance, the media playback system may have a library of possible soundscapes to accompany various media items, and suitable soundscapes can be assigned to particular media items (e.g., an energetic, up-beat soundscape with cheering crowd noises for a photo depicting a soccer player scoring a goal; a somber, wistful soundscape to accompany a photo of a deceased family member, etc.). In some implementations, a user may manually assign or select audio content to accompany particular media items.

If, in decision block 504, there is no corresponding spatial audio content identified, then the method 500 proceeds to block 506 with generating spatial audio content. In some instances, the media item may have no pre-existing audio content whatsoever (e.g., a simple photograph), and spatial audio can be generated for accompanying playback. In at least some situations, the media item may have pre-existing audio content, but it may be non-spatial audio (e.g., mono or stereo audio format). In such scenarios, the non-spatial audio can be modified to produce spatial audio, for instance by generating corresponding height and/or lateral channels to be mixed into or played back concurrently with the non-spatial audio content to produce more immersive spatial audio that retains features of the originally captured audio. In some cases, the pre-existing audio content can be modified, for instance to extend the recorded audio further (e.g., if 3 seconds of waves crashing is recorded, an additional 10 seconds of audio of waves crashing can be generated and appended to the pre-recorded audio).

As another example, the pre-recorded audio can be modified to produce an audio loop that can repeat continuously until the user terminates the session or a new media item is selected. In some implementations, an audio loop can be generated by separating the pre-recorded audio into foreground audio (e.g., a person speaking, laughing, etc.) and background audio (e.g., background chatter, environmental noise such as bird calls, wind noise, etc.). To create a perception of endless audio without a jarring transition between loops, the foreground audio can be played back only a single time, while the background audio can be looped continuously. In these and other examples, a user may optionally re-start the audio playback by interacting with the control device (e.g., pressing a “back” button on a playback UI).

Among examples, corresponding spatial audio can be generated either using pre-recorded audio as an input or without any pre-recorded audio. In various implementations, generation of the accompanying audio content can be based on characteristics of the identified media item and/or other contextual data, as discussed in more detail below with respect to FIG. 6. Generation of audio can use any of the generative audio techniques described in commonly owned International Patent Application Publication No. WO2022/109556, which is hereby incorporated by reference in its entirety.

Whether corresponding spatial audio content is identified (block 504), or spatial audio content is generated (block 506), the method 500 proceeds to block 508 with playing back spatial audio content associated with the media item. In some cases, playback may be performed via a playback device integrated or physically connected to the control device. In other cases, a control device can cause one or more playback devices to play back the audio content, for instance by transmitting data via a network interface over a local or wide area network to the one or more discrete playback devices. Multi-device audio playback may improve the immersiveness of the effect and provide enhanced playback of spatial audio content (e.g., creating surround-sound effects using a home theatre arrangement of several playback devices arranged about the user).

This process can be repeated continuously as new media items are detected via the sensor(s) of the control device. For example, a user may flip through pages of a photo book and present different images to the sensor (e.g., a camera) in turn. As each image is presented to the sensor, a corresponding tag or other indicia can be detected via the sensor, and corresponding audio content (e.g., spatial audio) can be obtained and/or generated for playback. By moving through different media items, the corresponding audio playback can transition over time. In some implementations, the audio content can be generated and/or modified so as to smooth the transition between audio content corresponding to a first media item and audio content corresponding to a second media item presented immediately after the first. In this manner, the user's viewing experience is enhanced by dynamic and contextually relevant audio content that seamlessly blends during transitions.

In some cases, a tag can be associated with a collection of individual media items. For instance, a photo album including a plurality of individual photos may have a tag such as a QR code on the cover. Individual media items within the collection may then have separate tags, or may be inspected directly (e.g., using image analysis) to identify the individual media items currently in view of the sensor. In some cases, multiple tags from multiple different media items may be detected simultaneously (e.g., a photo album with multiple photos on a given page may be simultaneously detected via the sensor). In such cases, the corresponding audio content may be based on parameters associated with each of the media items, in some instances taking the form of a blending of the two. In some instances, a user's interactions with particular media items can influence the generation of the audio content. For instance, if a user interacts with one media item (e.g., clicking on one digital photo in an array or collage of multiple photos), the audio corresponding to that particular media item may be made more prominent in the blend. Additionally or alternatively, the characteristics or other parameters associated with that particular media item may be weighted more heavily in generating the spatial audio content. In this manner, as the user interacts with different media items, the corresponding spatial audio content can be dynamically modified based on the particular user interactions.

Although several examples describe selecting, generating, and/or playing back audio content, the same techniques can be used to select, generate, and/or output lighting effects, video content, olfactory effects, tactile/vibration effects, or any other suitable output in the user's environment. (e.g., creating lighting for an associated smart light to create an atmospheric mood based on characteristics of the identified media item(s), generating ocean salt smell via a scent-generator device based on a beach photo, etc.).

FIG. 6 is a flow chart of a method 600 for generating spatial audio based on contextual data associated with a media item. The method 600 begins in block 602 with receiving an indication of a media item. This can involve, for instance, identifying a media item using a sensor of a control device as described elsewhere herein.

The method 600 continues in block 604 with determining a location, date, time, or other such parameter etc. associated with the media item. In various examples, this information may be obtained from metadata associated with the media item (e.g., geotag associated with a digital photo). The metadata may indicate a specific date and/or time of media content capture, or there may be a date, year, or time period that is simulated by the particular media content (e.g., a recent photo that has a retro 1960s style filter, a black-and-white photograph in the style of an early 19th century portrait, etc.). In some instances, even without a specific time or date, a time of day can be determined or obtained, such as morning/sunrise, afternoon, evening/sunset, etc. In some examples, metadata associated with the media item can also include other information, such as characteristics of the device used to capture the image (e.g., smartphone device make and model, camera specifications, etc.), optical settings associated with the camera when the media item was captured (e.g., focal length, exposure time, etc.), biometric data captured along with the media item (e.g., heartrate of the photographer may indicate the photographer was in a state of high arousal), or any other metadata associated with the media item.

Additionally or alternatively, one or more parameters of the media item can be determined based on direct inspection of the media item. For example, an image can be inspected and analyzed to determine location type (e.g., outdoor vs. indoor), to identify particular individuals in an image, to classify an image by emotional valence (e.g., happy, wistful, serious, sad, etc.), by activity captured (e.g., individual portrait, a posed group photo, photos with pets, sports activities, etc.), or any other suitable classifications.

In block 606, the method 600 involves generating audio content with characteristics associated with the determined location, date, time, or other parameter. For example, if location data indicates an image was taken in South Korea, then the accompanying audio content can be selected or generated to have elements of traditional Korean music or more modern K-pop. As another example, if location data indicates an image was taken in a sport stadium, then the accompanying audio content can include crowd noises, sports anthems, or other suitable content. In some implementations, historical weather data can be used to generate appropriate soundscapes. For instance, based on a location and date/time of a particular photograph, the media playback system can determine that the photograph was taken during a rainy day in London. As such, the accompanying audio can include rainfall sounds to create a more immersive viewing experience for the user. In some implementations, additional data specific to the user (e.g., travel history, musical taste, what other generative audio experiences the user has rated positively or negatively, current mood, etc.) may also inform what content is played back.

In some examples, generation of audio content can involve generating voice(s) of individuals identified in the image. For instance, a user may provide the media playback system with access to a generative artificial intelligence model capable of simulating that user's voice. When generating accompanying audio content for a particular media item, a simulation of the user's voice (or any other voices of individuals in the media item) can be generated and included within the audio content. For instance, if the media item is a photo of a mother next to her daughter who is blowing out birthday candles, a generative AI model can be used to simulate the mother's voice singing “Happy Birthday” to her daughter. If a large number of people are depicted in an image or video, background crowd noise can be generated using similar techniques.

In various examples, generation of the accompanying audio content can be based on one or more input parameters. Examples include metadata associated with the media item as discussed above (e.g., geolocation, time date, tagged individuals, etc.). Input parameters for generation of the accompanying audio content can also include one or more features identified visually within the media item (e.g., identified people, places, weather, time of day, saturation, contrast, luminosity, filters applied to the media item, etc.). Additionally or alternatively, input parameters for generation of the accompanying audio content may include pre-recorded audio accompanying the media item (e.g., audio accompanying a video clip or live photo) or user input associated with the media item (e.g., text, emojis, categorization into an album, etc.).

In block 608, the generated audio is played back via at least one playback device.

In some implementations, a user may wish to have different generated soundscapes for herself and for sharing with friends. For example, a user may share a media item such as a photo with her friends using an electronic message (e.g., sharing via a photo sharing app, social media site, text message, email, etc.) Corresponding audio content to accompany viewing of the photo can be generated based at least in part on text, emojis, or other characters within the accompanying message. For instance, the following examples may have completely different soundscapes generated when the same media item is shared with a friend based on the particular emoji used:

“Here's a picture from my trip [palm tree emoji]”

“Here's a picture from my trip [mountain emoji]”

“Here's a picture from my trip [confetti emoji]”

“Here's a picture from my trip [sad face emoji]”

Accordingly, text, emojis, or other characters provided by a user, such as when sharing a media item with others, can be an input parameter for the selection and/or generation of spatial audio content to accompany viewing of the media item. This can allow a user to easily influence the resulting audio content, for example to achieve audio that is more up-beat and happy or more mellow and absorptive, etc.

FIG. 700 is a flow chart illustrating a method 700 for generating audio based on audio captured before an image/video is taken. The method 700 begins in block 702 with receiving an indication of media content. This can involve, for instance, identifying a media item using a sensor of a control device as described elsewhere herein.

The method 700 continues in decision block 704 with determining whether there exists pre-capture audio data. For instance, some images or videos may include audio data captured immediately before the image data was captured. Such pre-capture audio data can be particularly useful for the present technology, as users often remember a particular moment differently than the way it is captured in a particular media item. The inventors have recognized that audio immediately preceding the moment that an image or video is captured is often more interesting, desirable, and/or useful for evaluating an overall tone of the image or video than the audio captured simultaneously with the image data.

If, in decision block 704, there is pre-capture audio data, then the method 700 proceeds to block 706 with generating audio content based on the pre-captured audio data. This audio can be based only on the pre-captured audio data, or may be based on both the pre-captured audio data and audio data captured concurrently with the image data of the media item. In various examples, the pre-capture audio data can be manipulated or modified to create accompanying audio content (e.g., extended, looped, etc.). In block 708, the generated audio content is played back via at least one playback device.

FIG. 8 is a flow chart illustrating a method 800 for adjusting audio content based on particular filter(s) associated with a media item. The method 800 begins in block 802 with receiving an indication of media item. This can involve, for instance, identifying a media item using a sensor of a control device as described elsewhere herein.

The method 800 continues in block 804 with identifying image filter(s) associated with the media item. Image filters can be identified via metadata associated with the media item. In some instances, an image can be inspected directly (e.g., optical inspection or evaluation of the image file itself) to identify any image filters that were used in generating the media item. In some implementations, a user may apply various image filters in real-time, for example using a photo editing application, and the particular image being applied at any given time can be identified and detected by or transmitted to the control device.

In block 806, the method 800 involves determining one or more audio parameters associated with the image filter(s). And in block 808, audio is played back according to the determined audio parameter(s). For instance, particular image filters may provide information regarding the content depicted within the media item, the user's relationship to or perspective on the media item, or an intended use of such a media item. For example, an image filter that adds dog ears to people's faces indicates a playful, lighthearted mood. In contrast, a black-and-white or sepia filter may indicate a desire for a more serious, sober, or reflective mood. As such, these different filters may call for different accompanying audio content, even if the underlying original media item is identical.

Among examples, audio parameters that can be adjusted include emotional categorization (e.g., more or less happy or sad, more or less excited or aroused, etc.), genre, selection of instrument(s), EQ settings (e.g., frequency response filters, bass treble), dynamics (e.g., volume), tempo, tonal/phrasing repetition, selection of ambient sounds (e.g., ocean waves, animal sounds, wind noise, etc.). These and other such aspects of accompanying audio content can be selected and/or modified based at least in part on the identified filter(s) applied to the media item.

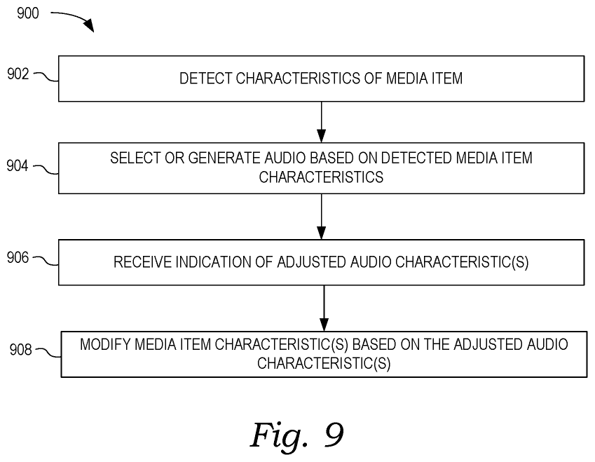

FIG. 9 is a flow chart illustrating a method 900 for modifying a media item based on audio characteristics selected or modified by a user. The inventors have recognized that an image or video is an entry point to a memory. One upshot of this insight is that an aural aspect of a memory may have a stronger connection to how someone actually remembers an event than the visual aspect. Accordingly, by receiving user feedback in the form of adjustments to the accompanying audio content, the media playback system can modify a media item to more closely match the user's desired recollection.

The method 900 begins in block 902 with detecting characteristics of a media item. This can involve, for instance, identifying a media item using a sensor of a control device as described elsewhere herein. After identifying the media item, corresponding characteristics can be obtained, e.g., via lookup in a local or remote database, as discussed previously. Additionally or alternatively, the media item can be inspected directly to identify or extract characteristics of the media item. For instance, image recognition and analysis can be used to identify individuals within an image or video, to identify a location, a setting, etc. In some examples, characteristics of the media item can include one or more image or video parameters (e.g., color spectrum, color temperature, luminosity, contrast). In some instances, EXIF data can be analyzed to determine, for example, camera type/model, aperture (i.e., depth of field), shutter speed, etc. As noted previously, particular filter(s) applied to the media item can also be identified.

The method 900 continues in block 904 with selecting or generating audio based on the detected characteristics of the media item. As described previously, the generated audio can be based on pre-existing audio content (e.g., a portion of audio captured alongside the original visual media item) or may be wholly new audio content generated based on the identified characteristics. In various implementations, the audio may include prerendered media content, generative audio, dynamic or interactive audio content, or any combination thereof.

In some scenarios, however, a user may be dissatisfied with the audio selected or generated to be played back to accompany the media item. This may be due simply to user preference, or it may be the case that a user's memory of an event captured in the media item differs from the media item itself in important ways. For example, a scene that the user remembers fondly may nonetheless appear melancholy based on the characteristics of the photograph alone. Accordingly, when the system generates or selects accompanying melancholy music, the user may wish to override or modify the audio content, for instance to select happier, more up-beat audio content. In such cases, the user may adjust the audio content, such as by selecting a different audio track or soundscape to accompany the media item, or by providing corrective feedback such as “more happy,” “more sad,” “slower,” “more energetic,” etc. In some instances, these and other such modification options can be presented to a user via a user interface, allowing the user to easily provide input for audio modifications.

In block 906, the method 900 involves receiving an indication of adjusted audio characteristics. For instance, a user may provide input to adjust audio characteristics (e.g., via a voice input, a controller device, or any other suitable input mechanism). Adjustments can include, for instance, selecting different audio content, providing directional input such as “more happy” or “more sad” as noted above, adjusting the EQ, volume, playback responsibilities of various playback devices, generative audio input parameters, or any other suitable adjustments to audio characteristics.

In block 908, the media item characteristics can be modified based on the adjusted audio characteristics. For example, if the user's audio modifications indicate that the user's recollection of an event depicted in a media item is a happy one (and happier than would otherwise be determined based on the media item characteristics alone), the media playback system may modify the media item itself to more closely mirror the user's perceived recollection. In various examples, filters, delays, crops, speed adjustments, or other image or video editing techniques can be used to manipulate or modify the media item as appropriate.

In some examples, based on the selection or modification of audio content by the user, the system may alter media item characteristics using artificial intelligence image manipulation techniques or other approaches. For example, the system may alter the sky from a cloudy one to a sunny one. Or perhaps the system may change facial expressions of one or more people identified in the photo/image from sad or neutral to happy or upbeat. As another example, the system may select a different image or video filter. This approach can further allow a user to control her viewing experience by modifying media items based on her selection or modification of the accompanying audio content.

### V. Conclusion

The above discussions relating to playback devices, controller devices, playback zone configurations, and media content sources provide only some examples of operating environments within which functions and methods described below may be implemented. Other operating environments and/or configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software examples or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “example” means that a particular feature, structure, or characteristic described in connection with the example can be included in at least one example embodiment or implementation of an invention. The appearances of this phrase in various places in the specification are not necessarily all referring to the same example, nor are separate or alternative examples mutually exclusive of other examples. As such, the examples described herein, explicitly and implicitly understood by one skilled in the art, can be combined with other examples.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples of the present disclosure can be practiced without certain, specific details. In other instances, well known methods, procedures, components, and circuitry have not been described in detail to avoid unnecessarily obscuring examples of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The disclosed technology is illustrated, for example, according to various examples described below. Various examples of examples of the disclosed technology are described as numbered examples for convenience. These are provided as examples and do not limit the disclosed technology. It is noted that any of the dependent examples may be combined in any combination, and placed into a respective independent example. The other examples can be presented in a similar manner.

Example 1. A media playback system comprising: an audio playback device; and a control device separate from the audio playback device, the control device comprising: a receptacle configured to receive a physical token thereon; a sensor coupled to the receptacle and configured to sense a tag of the physical token; a network interface; one or more processors; and data storage that, when executed by the one or more processors, cause the system to perform operations comprising: obtaining data by sensing a tag of a physical token via the sensor; based on the obtained data, transmitting, via the network interface, a request for media content to one or more remote computing devices associated with a media content service; and causing playback of the requested media content via the audio playback device.

Example 2. The media playback system of any one of the Examples herein, wherein the obtained data is first data, the tag is a first tag, and the physical token is a first physical token, the operations further comprising: after obtaining the first data, obtaining second data by sensing a second tag of a second physical token via the sensor; and based on both the first data and the second data, transmitting, via the network interface, the request for media content to one or more remote computing devices associated with the media content service.

Example 3. The media playback system of any one of the Examples herein, wherein the tag comprises one or more of: an optically readable tag (e.g., QR code, barcode, infrared ink, etc.) or an electromagnetically readable tag (e.g., near-field communication (NFC) transponder, radiofrequency identification (RFID) transponder, etc.).

Example 4. The media playback system of any one of the Examples herein, wherein the physical token comprises a plurality of tags, only one of which may be read by the sensor at a given time depending on the orientation of the physical token with respect to the receptacle.

Example 5. The media playback system of any one of the Examples herein, wherein the data obtained by sensing the tag comprises one or more of: a URI, a URL, media content metadata (e.g., artist or track name), or a generative media input identifier.

Example 6. The media playback system of any one of the Examples herein, wherein the requesting media content comprises providing one or more inputs for a generative media content engine to produce generative media content.

Example 7. The media playback system of any one of the Examples herein, wherein the first data and the second data each comprise inputs to a generative media content engine.

Example 8. The media playback system of any one of the Examples herein, wherein the first data corresponds to a first item of media content and the second data corresponds to a second item of media content, and wherein the operations further comprise arranging the first item of media content and the second item of media content into a playback queue.

Example 9. The media playback system of any one of the Examples herein, wherein the operations further comprise, based on the obtained data, outputting an audible indication of the media content to be played back via the audio playback device.

Example 10. The media playback system of any one of the Examples herein, wherein the control device further comprises a user input component (e.g., knob, button, touch-sensitive surface, etc.) for controlling media playback.

Example 11. The media playback system of any one of the Examples herein, wherein the control device further comprises a user input component (e.g., knob, button, touch-sensitive surface, etc.) that, when activated, causes a currently playing media item to be assigned to the tag sensed by the sensor.

Example 12. The media playback system of any one of the Examples herein, wherein the operations comprise, based on the obtained data, causing, via the network interface, a light source to modulate a lighting parameter from a first parameter to a second parameter

Example 13. The media playback system of any one of the Examples herein, wherein the operations comprise identifying, based on the obtained data, the light source, wherein identifying the light source comprises (i) detecting one or more light sources available to the media playback system, (ii) determining a distance between at least one of the one or more available light sources and at least one of the control device and the audio playback device, and (iii) selecting the light source from the one or more available light sources based on the determined distance between the light source and at least one of the control device and the audio playback device

Example 14. The media playback device of any one of the Examples herein, wherein the operations comprise detecting a change in an orientation of the tag from a first orientation to a second orientation, and further comprise modulating playback of the requested media content via the audio playback device based on the detected second orientation of the tag.

Example 15. A method comprising: sensing, via a sensor of a control device, a tag of a physical token received on a receptacle of the control device; based on the obtained data, transmitting, via the network interface, a request for media content to one or more remote computing devices associated with a media content service; and causing playback of the requested media content via the audio playback device.

Example 16. The method of any one of the Examples herein, wherein the obtained data is first data, the tag is a first tag, and the physical token is a first physical token, the operations further comprising: after obtaining the first data, obtaining second data by sensing a second tag of a second physical token via the sensor; and based on both the first data and the second data, transmitting, via the network interface, the request for media content to one or more remote computing devices associated with the media content service.

Example 17. The method of any one of the Examples herein, wherein the tag comprises one or more of: an optically readable tag (e.g., QR code, barcode, infrared ink, etc.) or an electromagnetically readable tag (e.g., near-field communication (NFC) transponder, radiofrequency identification (RFID) transponder, etc.).

Example 18. The method of any one of the Examples herein, wherein the physical token comprises a plurality of tags, only one of which may be read by the sensor at a given time depending on the orientation of the physical token with respect to the receptacle.

Example 19. The method of any one of the Examples herein, wherein the data obtained by sensing the tag comprises one or more of: a URI, a URL, media content metadata (e.g., artist or track name), or a generative media input identifier.

Example 20. The method of any one of the Examples herein, wherein the requesting media content comprises providing one or more inputs for a generative media content engine to produce generative media content.

Example 21. The method of any one of the Examples herein, wherein the first data and the second data each comprise inputs to a generative media content engine.

Example 22. The method of any one of the Examples herein, wherein the first data corresponds to a first item of media content and the second data corresponds to a second item of media content, and wherein the operations further comprise arranging the first item of media content and the second item of media content into a playback queue.

Example 23. The method of any one of the Examples herein, further comprising, based on the obtained data, outputting an audible indication of the media content to be played back via the audio playback device.

Example 24. The method of any one of the Examples herein, wherein the control device further comprises a user input component (e.g., knob, button, touch-sensitive surface, etc.) for controlling media playback.

Example 25. The method of any one of the Examples herein, wherein the control device further comprises a user input component (e.g., knob, button, touch-sensitive surface, etc.) that, when activated, causes a currently playing media item to be assigned to the tag sensed by the sensor.

Example 26. The method of any one of the Examples herein, further comprising, based on the obtained data, causing, via the network interface, a light source to modulate a lighting parameter from a first parameter to a second parameter

Example 27. The method of any one of the Examples herein, further comprising identifying, based on the obtained data, the light source, wherein identifying the light source comprises (i) detecting one or more light sources available to the media playback system, (ii) determining a distance between at least one of the one or more available light sources and at least one of the control device and the audio playback device, and (iii) selecting the light source from the one or more available light sources based on the determined distance between the light source and at least one of the control device and the audio playback device

Example 28. The method of any one of the Examples herein, further comprising detecting a change in an orientation of the tag from a first orientation to a second orientation, and further comprise modulating playback of the requested media content via the audio playback device based on the detected second orientation of the tag.

Example 29. One or more tangible, non-transitory computer-readable media storing instructions that, when executed by one or more processors of a media playback system, cause the media playback system to perform operations comprising: obtaining data by sensing a tag of a physical token via a sensor of a control device, the control device comprising a receptacle configured to receive the physical token thereon; based on the obtained data, transmitting, via a network interface of the control device, a request for media content to one or more remote computing devices associated with a media content service; and causing playback of the requested media content via an audio playback device that is separate from the control device.

Example 30. The computer-readable media of any one of the Examples herein, wherein the obtained data is first data, the tag is a first tag, and the physical token is a first physical token, the operations further comprising: after obtaining the first data, obtaining second data by sensing a second tag of a second physical token via the sensor; and based on both the first data and the second data, transmitting, via the network interface, the request for media content to one or more remote computing devices associated with the media content service.

Example 31. The computer-readable media of any one of the Examples herein, wherein the tag comprises one or more of: an optically readable tag (e.g., QR code, barcode, infrared ink, etc.) or an electromagnetically readable tag (e.g., near-field communication (NFC) transponder, radiofrequency identification (RFID) transponder, etc.).

Example 32. The computer-readable media of any one of the Examples herein, wherein the physical token comprises a plurality of tags, only one of which may be read by the sensor at a given time depending on the orientation of the physical token with respect to the receptacle.

Example 33. The computer-readable media of any one of the Examples herein, wherein the data obtained by sensing the tag comprises one or more of: a URI, a URL, media content metadata (e.g., artist or track name), or a generative media input identifier.

Example 34. The computer-readable media of any one of the Examples herein, wherein the requesting media content comprises providing one or more inputs for a generative media content engine to produce generative media content.

Example 35. The computer-readable media of any one of the Examples herein, wherein the first data and the second data each comprise inputs to a generative media content engine.

Example 36. The computer-readable media of any one of the Examples herein, wherein the first data corresponds to a first item of media content and the second data corresponds to a second item of media content, and wherein the operations further comprise arranging the first item of media content and the second item of media content into a playback queue.

Example 37. The computer-readable media of any one of the Examples herein, wherein the operations further comprise, based on the obtained data, outputting an audible indication of the media content to be played back via the audio playback device.

Example 38. The computer-readable media of any one of the Examples herein, wherein the control device further comprises a user input component (e.g., knob, button, touch-sensitive surface, etc.) for controlling media playback.

Example 39. The computer-readable media of any one of the Examples herein, wherein the control device further comprises a user input component (e.g., knob, button, touch-sensitive surface, etc.) that, when activated, causes a currently playing media item to be assigned to the tag sensed by the sensor.

Example 40. The computer-readable media of any one of the Examples herein, wherein the operations comprise, based on the obtained data, causing, via the network interface, a light source to modulate a lighting parameter from a first parameter to a second parameter.

Example 41. The computer-readable media of any one of the Examples herein, wherein the operations comprise identifying, based on the obtained data, the light source, wherein identifying the light source comprises (i) detecting one or more light sources available to the media playback system, (ii) determining a distance between at least one of the one or more available light sources and at least one of the control device and the audio playback device, and (iii) selecting the light source from the one or more available light sources based on the determined distance between the light source and at least one of the control device and the audio playback device

Example 42. The computer-readable media of any one of the Examples herein, wherein the operations comprise detecting a change in an orientation of the tag from a first orientation to a second orientation, and further comprise modulating playback of the requested media content via the audio playback device based on the detected second orientation of the tag.

Example 43. A media playback system comprising: a playback device comprising; a first network interface; a first transducer; and a second transducer oriented at a vertical angle with respect to the first transducer; and a control device comprising: a sensor; a second network interface; one or more processors; and data storage that, when executed by the one or more processors, cause the media playback system to perform operations comprising: receiving sensor data via the sensor; identifying, based on the received sensor data, a media item characteristic; obtaining spatial audio content corresponding to the media item characteristic, wherein obtaining the spatial audio content comprises generating novel audio content based at least in part on the identified media item characteristic; and causing, via the second network interface, playback of the obtained spatial audio content via the first and second transducers of the playback device.

Example 44. The media playback system of any one of the Examples herein, wherein the sensor comprises an optical sensor configured to identify the media item or detect a tag associated with the media item (e.g., camera to analyze image, detect QR code, infrared signature, etc.)

Example 45. The media playback system of any one of the Examples herein, wherein the sensor comprises an electromagnetic sensor configured to identify an electromagnetic tag associated with the media item (e.g., RFID, NFC, etc.).

Example 46. The media playback system of any one of the Examples herein, wherein the media item comprises an image or a video.

Example 47. The media playback system of any one of the Examples herein, wherein obtaining spatial audio content comprises obtaining pre-recorded audio content corresponding to the media item.

Example 48. The media playback system of any one of the Examples herein, wherein generating the novel audio content based at least in part on the media item characteristic comprises generating, via the playback device, algorithmically generated content.

Example 49. The media playback system of any one of the Examples herein, further comprising receiving, via the media playback system, one or more input parameters, wherein the obtaining spatial audio content is based on the one or more input parameters.

Example 50. The media playback system of any one of the Examples herein, wherein the one or more input parameters comprise one or more of: metadata associated with the media item (e.g., geolocation, time, date, identified people, etc.); one or more features identified visually within the media item (e.g., identified people, places, weather, time of day, color spectrum, color temperature, luminosity, filters applied to the media item, etc.); pre-recorded audio accompanying the media item (e.g., audio accompanying a video clip or live photo); or user input associated with the media item (e.g., text, emojis, categorization into an album, etc.).

Example 51. The media playback system of any one of the Examples herein, wherein the pre-recorded audio comprises first audio captured prior to a shutter press and second audio captured after the shutter press, wherein generating the novel audio content is based on the first audio, and wherein the obtained spatial audio excludes the second audio.

Example 52. The media playback system of any one of the Examples herein, wherein obtaining spatial audio corresponding to the media item comprises receiving a user selection of spatial audio, and wherein the operations further comprise producing a modified version of the media item based on the user's selection of spatial audio.

Example 53. The media playback system of any one of the Examples herein, wherein the media item is a first visual media item and the spatial audio content is first spatial audio content, and wherein the operations further comprise: identifying a second visual media item via the sensor, the second visual media item different from the first; obtaining second spatial audio content corresponding to the second visual media item, the second spatial audio content different from the first; transitioning playback, via the playback device, from the first spatial audio content to the second spatial audio content.

Example 54. The media playback system of any one of the Examples herein, wherein the playback device is a first playback device, further comprising a second playback device, wherein the operations include transmitting, via the second network device, first audio content and second audio content to the second playback device, wherein causing playback of the obtained spatial audio comprises causing the first playback device to play back the first audio content in substantial synchrony with playback of the second audio content via the second playback device.

Example 55. A method performed by a media playback system comprising a playback device and a control device, the method comprising: receiving sensor data via a sensor of the control device; identifying, based on the received sensor data, a media item characteristic; obtaining spatial audio content corresponding to the media item characteristic, wherein obtaining the spatial audio content comprises generating novel audio content based at least in part on the identified media item characteristic; and causing, via a network interface of the control device, playback of the obtained spatial audio content via first and second transducers of the playback device, wherein the second transducer is oriented at a vertical angle with respect to the first transducer.

Example 56. The method of any one of the Examples herein, wherein the sensor comprises an optical sensor configured to identify the media item or detect a tag associated with the media item (e.g., camera to analyze image, detect QR code, infrared signature, etc.)

Example 57. The method of any one of the Examples herein, wherein the sensor comprises an electromagnetic sensor configured to identify an electromagnetic tag associated with the media item (e.g., RFID, NFC, etc.).

Example 58. The method of any one of the Examples herein, wherein the media item comprises an image or a video.

Example 59. The method of any one of the Examples herein, wherein obtaining spatial audio content comprises obtaining pre-recorded audio content corresponding to the media item.

Example 60. The method of any one of the Examples herein, wherein generating the novel audio content based at least in part on the media item characteristic comprises generating, via the playback device, algorithmically generated content.

Example 61. The method of any one of the Examples herein, further comprising receiving, via the media playback system, one or more input parameters, wherein the obtaining spatial audio content is based on the one or more input parameters.

Example 62. The method of any one of the Examples herein, wherein the one or more input parameters comprise one or more of: metadata associated with the media item (e.g., geolocation, time, date, identified people, etc.); one or more features identified visually within the media item (e.g., identified people, places, weather, time of day, color spectrum, color temperature, luminosity, filters applied to the media item, etc.); pre-recorded audio accompanying the media item (e.g., audio accompanying a video clip or live photo); or user input associated with the media item (e.g., text, emojis, categorization into an album, etc.).

Example 63. The method of any one of the Examples herein, wherein the pre-recorded audio comprises first audio captured prior to a shutter press and second audio captured after the shutter press, wherein generating the novel audio content is based on the first audio, and wherein the obtained spatial audio excludes the second audio.

Example 64. The method of any one of the Examples herein, wherein obtaining spatial audio corresponding to the media item comprises receiving a user selection of spatial audio, and wherein the method further comprises producing a modified version of the media item based on the user's selection of spatial audio.

Example 65. The method of any one of the Examples herein, wherein the media item is a first visual media item and the spatial audio content is first spatial audio content, the method further comprising: identifying a second visual media item via the sensor, the second visual media item different from the first; obtaining second spatial audio content corresponding to the second visual media item, the second spatial audio content different from the first; transitioning playback, via the playback device, from the first spatial audio content to the second spatial audio content.

Example 66. The method of any one of the Examples herein, wherein the playback device is a first playback device, the method further comprising: transmitting first audio content and second audio content to a second playback device of the media playback system, wherein causing playback of the obtained spatial audio comprises causing the first playback device to play back the first audio content in substantial synchrony with playback of the second audio content via the second playback device.

Example 67. One or more tangible, non-transitory computer-readable media storing instructions that, when executed by one or more processors of a media playback system comprising a playback device and a control device, cause the media playback system to perform operations comprising: receiving sensor data via a sensor of the control device; identifying, based on the received sensor data, a media item characteristic; obtaining spatial audio content corresponding to the media item characteristic, wherein obtaining the spatial audio content comprises generating novel audio content based at least in part on the identified media item characteristic; and causing, via a network interface of the control device, playback of the obtained spatial audio content via first and second transducers of the playback device, wherein the second transducer is oriented at a vertical angle with respect to the first transducer.

Example 68. The one or more computer-readable media of any one of the Examples herein, wherein the sensor comprises an optical sensor configured to identify the media item or detect a tag associated with the media item (e.g., camera to analyze image, detect QR code, infrared signature, etc.)

Example 69. The one or more computer-readable media of any one of the Examples herein, wherein the sensor comprises an electromagnetic sensor configured to identify an electromagnetic tag associated with the media item (e.g., RFID, NFC, etc.).

Example 70. The one or more computer-readable media of any one of the Examples herein, wherein the media item comprises an image or a video.

Example 71. The one or more computer-readable media of any one of the Examples herein, wherein obtaining spatial audio content comprises obtaining pre-recorded audio content corresponding to the media item.

Example 72. The one or more computer-readable media of any one of the Examples herein, wherein generating the novel audio content based at least in part on the media item characteristic comprises generating, via the playback device, algorithmically generated content.

Example 73. The one or more computer-readable media of any one of the Examples herein, wherein the operations further comprise receiving, via the media playback system, one or more input parameters, wherein the obtaining spatial audio content is based on the one or more input parameters.

Example 74. The one or more computer-readable media of any one of the Examples herein, wherein the one or more input parameters comprise one or more of: metadata associated with the media item (e.g., geolocation, time, date, identified people, etc.); one or more features identified visually within the media item (e.g., identified people, places, weather, time of day, color spectrum, color temperature, luminosity, filters applied to the media item, etc.); pre-recorded audio accompanying the media item (e.g., audio accompanying a video clip or live photo); or user input associated with the media item (e.g., text, emojis, categorization into an album, etc.).

Example 75. The one or more computer-readable media of any one of the Examples herein, wherein obtaining spatial audio corresponding to the media item comprises receiving a user selection of spatial audio, and wherein the operations further comprise producing a modified version of the media item based on the user's selection of spatial audio.

Example 76. The one or more computer-readable media of any one of the Examples herein, wherein the media item is a first visual media item and the spatial audio content is first spatial audio content, the operations further comprising: identifying a second visual media item via the sensor, the second visual media item different from the first; obtaining second spatial audio content corresponding to the second visual media item, the second spatial audio content different from the first; transitioning playback, via the playback device, from the first spatial audio content to the second spatial audio content.

Example 77. The one or more computer-readable media of any one of the Examples herein, wherein the pre-recorded audio comprises first audio captured prior to a shutter press and second audio captured after the shutter press, wherein generating the novel audio content is based on the first audio, and wherein the obtained spatial audio excludes the second audio.

Example 78. The one or more computer-readable media of any one of the Examples herein, wherein the playback device is a first playback device, the operations further comprising: transmitting first audio content and second audio content to a second playback device of the media playback system, wherein causing playback of the obtained spatial audio comprises causing the first playback device to play back the first audio content in substantial synchrony with playback of the second audio content via the second playback device.

1. A media playback system comprising:
a playback device comprising;
a first network interface;
a first transducer; and
a second transducer oriented at a vertical angle with respect to the first transducer; and
a control device comprising:
a sensor;
a second network interface;
one or more processors; and
data storage that, when executed by the one or more processors, cause the media playback system to perform operations comprising:
receiving sensor data via the sensor;
identifying, based on the received sensor data, a media item characteristic;
obtaining spatial audio content corresponding to the media item characteristic, wherein obtaining the spatial audio content comprises generating novel audio content based at least in part on the identified media item characteristic; and
causing, via the second network interface, playback of the obtained spatial audio content via the first and second transducers of the playback device.

2. The media playback system of claim 1, wherein obtaining spatial audio content comprises obtaining pre-recorded audio content corresponding to the media item.

3. The media playback system of claim 1, further comprising receiving, via the media playback system, one or more input parameters, wherein the obtaining spatial audio content is based on the one or more input parameters.

4. The media playback system of claim 3, wherein the one or more input parameters comprise one or more of:
metadata associated with the media item;
one or more features identified visually within the media item;
pre-recorded audio accompanying the media item; or
user input associated with the media item.

5. The media playback system of claim 1, wherein obtaining spatial audio corresponding to the media item comprises receiving a user selection of spatial audio, and wherein the operations further comprise producing a modified version of the media item based on the user's selection of spatial audio.

6. The media playback system of claim 1, wherein the media item is a first visual media item and the spatial audio content is first spatial audio content, and wherein the operations further comprise:
identifying a second visual media item via the sensor, the second visual media item different from the first;
obtaining second spatial audio content corresponding to the second visual media item, the second spatial audio content different from the first; and
transitioning playback, via the playback device, from the first spatial audio content to the second spatial audio content.

7. The media playback system of claim 1, wherein the playback device is a first playback device, further comprising a second playback device,
wherein the operations include transmitting, via the second playback device, first audio content and second audio content to the second playback device,
wherein causing playback of the obtained spatial audio comprises causing the first playback device to play back the first audio content in substantial synchrony with playback of the second audio content via the second playback device.

8. A method performed by a media playback system comprising a playback device and a control device, the method comprising:
receiving sensor data via a sensor of the control device;
identifying, based on the received sensor data, a media item characteristic;
obtaining spatial audio content corresponding to the media item characteristic, wherein obtaining the spatial audio content comprises generating novel audio content based at least in part on the identified media item characteristic; and
causing, via a network interface of the control device, playback of the obtained spatial audio content via first and second transducers of the playback device, wherein the second transducer is oriented at a vertical angle with respect to the first transducer.

9. The method of claim 8, wherein obtaining spatial audio content comprises obtaining pre-recorded audio content corresponding to the media item.

10. The method of claim 8, further comprising receiving, via the media playback system, one or more input parameters, wherein the obtaining spatial audio content is based on the one or more input parameters.

11. The method of claim 10, wherein the one or more input parameters comprise one or more of:
metadata associated with the media item;
one or more features identified visually within the media item;
pre-recorded audio accompanying the media item; or
user input associated with the media item.

12. The method of claim 8, wherein obtaining spatial audio corresponding to the media item comprises receiving a user selection of spatial audio, and wherein the method further comprises producing a modified version of the media item based on the user's selection of spatial audio.

13. The method of claim 8, wherein the media item is a first visual media item and the spatial audio content is first spatial audio content, the method further comprising:
identifying a second visual media item via the sensor, the second visual media item different from the first;
obtaining second spatial audio content corresponding to the second visual media item, the second spatial audio content different from the first; and
transitioning playback, via the playback device, from the first spatial audio content to the second spatial audio content.

14. The method of claim 8, wherein the playback device is a first playback device, the method further comprising:
transmitting first audio content and second audio content to a second playback device of the media playback system,
wherein causing playback of the obtained spatial audio comprises causing the first playback device to play back the first audio content in substantial synchrony with playback of the second audio content via the second playback device.

15. One or more tangible, non-transitory computer-readable media storing instructions that, when executed by one or more processors of a media playback system comprising a playback device and a control device, cause the media playback system to perform operations comprising:
receiving sensor data via a sensor of the control device;
identifying, based on the received sensor data, a media item characteristic;
obtaining spatial audio content corresponding to the media item characteristic, wherein obtaining the spatial audio content comprises generating novel audio content based at least in part on the identified media item characteristic; and
causing, via a network interface of the control device, playback of the obtained spatial audio content via first and second transducers of the playback device, wherein the second transducer is oriented at a vertical angle with respect to the first transducer.

16. The one or more computer-readable media of claim 15, wherein obtaining spatial audio content comprises obtaining pre-recorded audio content corresponding to the media item.

17. The one or more computer-readable media of claim 15, wherein the operations further comprise receiving, via the media playback system, one or more input parameters, wherein the obtaining spatial audio content is based on the one or more input parameters.

18. The one or more computer-readable media of claim 17, wherein the one or more input parameters comprise one or more of:
metadata associated with the media item;
one or more features identified visually within the media item;
pre-recorded audio accompanying the media item; or
user input associated with the media item.

19. The one or more computer-readable media of claim 15, wherein obtaining spatial audio corresponding to the media item comprises receiving a user selection of spatial audio, and wherein the operations further comprise producing a modified version of the media item based on the user's selection of spatial audio.

20. The one or more computer-readable media of claim 15, wherein the media item is a first visual media item and the spatial audio content is first spatial audio content, the operations further comprising:
identifying a second visual media item via the sensor, the second visual media item different from the first;
obtaining second spatial audio content corresponding to the second visual media item, the second spatial audio content different from the first; and
transitioning playback, via the playback device, from the first spatial audio content to the second spatial audio content.
